(19) United States
(12) Patent Application Publication
(10) Pub. No.: US 2025/0303639 A1
(43) Pub. Date: Oct. 2, 2025

(54) ADAPTIVE LIGHT SHEET FOR REDUCING OFF-TARGET PHOTOEXCITATION IN VOLUMETRIC PRINTING INCLUDING TWO WAVELENGTHS

(71) Applicant: QUADRATIC 3D, INC., CHARLESTOWN, MA (US)

(72) Inventors: SAMUEL N. SANDERS, ARLINGTON, MA (US); KAREN TWIETMEYER, BELMONT, MA (US)

(21) Appl. No.: 19/232,543

(22) Filed: Jun. 9, 2025

Related U.S. Application Data
(63) Continuation of application No. PCT/US2023/083218, filed on Dec. 8, 2023.
(60) Provisional application No. 63/431,648, filed on Dec. 9, 2022.

(51) Int. Cl. B29C 64/291; B29C 64/129; B33Y 10/00; B33Y 30/00; B33Y 70/00

(52) U.S. Cl. CPC B29C 64/291; B29C 64/129; B33Y 10/00; B33Y 30/00; B33Y 70/00

(57) ABSTRACT

The present invention includes methods for reducing photoexcitation of a photoswitchable photoinitiator in volumetric printing including a volume of a photohardenable composition at locations in the volume at which intersection of two wavelengths does not occur; methods of three-dimensional (3D) printing including dual-wavelength photoexcitation of a photohardenable composition included in a volume, the method including photoexcitation by a modified or controllably-sized light sheet including a first wavelength and an optical projection including a second wavelength; and methods for extending the reuse-printing lifetime of a photohardenable composition including a photoswitchable photoinitiator. Preferably the photohardenable composition includes the dual-wavelength photoinitiator and a photohardenable resin component. The present invention also includes a photohardenable composition including a photoswitchable photoinitiator with an improved reuse-printing lifetime.

### CROSS-REFERENCE TO RELATED APPLICATIONS

This application is a continuation of International Application No. PCT/US2023/083218 filed on Dec. 8, 2023, which International Application claims priority to U.S. Provisional Patent Application No. 63/431,648 filed on Dec. 9, 2022, each of the foregoing applications being hereby incorporated herein by reference in its entirety for all purposes.

### TECHNICAL FIELD OF THE INVENTION

The present invention relates to the technical field of dual-color light-activated polymerization and related three-dimensional printing methods and compositions.

### BRIEF SUMMARY OF THE INVENTION

The present invention includes methods for reducing photoexcitation of a dual-wavelength photoinitiator in volumetric printing including a volume of a photohardenable composition at locations in the volume at which intersection of two wavelengths does not occur; methods of three-dimensional (3D) volumetric printing including dual-wavelength photoexcitation of a photohardenable composition including dual-wavelength photoinitiator, the method including photoexcitation by a controllably-sized and configured light sheet including a first wavelength and an optical projection including a second wavelength; and methods for extending the reuse-printing lifetime of a photohardenable composition including a dual-wavelength photoinitiator. The present invention also includes a photohardenable composition including a dual-wavelength photoinitiator with an improved reuse-printing lifetime. Preferably the photohardenable composition includes a dual-wavelength photoinitiator comprising a photoswitchable photoinitiator and a photohardenable resin component.

In accordance with one aspect of the present invention, there is provided a method of three-dimensional (3D) printing, the method comprising exposing a volume of a photohardenable composition including a photoswitchable photoinitiator and a photohardenable resin component to a projected optical image created by second excitation light and a light sheet generated with first excitation light such that the optical image and light sheet intersect, preferably in a common plane, at a selected location in the volume to induce polymerization or cross-linking of the composition at the selected location, wherein the light sheet is modified in one or more regions to reduce regions of the volume exposed only to first excitation light thereby reducing photoexcitation of the photoswitchable photoinitiator in the photohardenable composition.

Reducing regions of the volume exposed only to first excitation light can advantageously extend the reuse printing lifetime of a photohardenable composition including a photoswitchable photoinitiator.

In accordance with another aspect of the present invention, there is provided a method of three-dimensional (3D) printing, the method comprising exposing a volume of a photohardenable composition including a photoswitchable photoinitiator and a photohardenable resin component to a projected optical image created by second excitation light and a light sheet generated with first excitation light such that the optical image and light sheet intersect in a common plane at a selected location in the volume to induce polymerization or cross-linking of the composition at the selected location, wherein the size of the light sheet intersecting with the optical image is controlled to reduce regions of the volume exposed only to first excitation light thereby reducing photoexcitation of the photoswitchable photoinitiator in the photohardenable composition.

Reducing regions of the volume exposed only to first excitation light can advantageously extend the reuse printing lifetime of a photohardenable composition including a photoswitchable photoinitiator.

In accordance with another aspect of the present invention, there is provided a method of volumetric printing with reduced photoexcitation of a photoswitchable photoinitiator included in the printing volume, the method comprising:
a. providing a volume of a photohardenable composition including the photoswitchable photoinitiator and a photohardenable resin component, wherein the photoswitchable photoinitiator is activatable by exposure to a first excitation light including a first wavelength and a second excitation light including a second wavelength to induce a crosslinking or polymerization reaction in the photohardenable component, wherein the first and second wavelengths are different;
b. projecting an optical image generated with the second excitation light along a projection axis to a selected location in the volume, wherein the optical image is oriented perpendicular to the projection axis;
c. generating a planar configuration of light including the first excitation light and directing the planar configuration of light along a light sheet illumination axis through the volume such that the optical image and the planar configuration of light intersect at the selected location, preferably in a common plane, wherein the planar configuration has a height dimension that is controlled to be less than the height dimension of the volume through which the light sheet is passed and greater than or equal to the maximum height dimension of the projected optical image in the volume at the selected location, and wherein the planar configuration of light at least fully overlaps the projected optical image in the volume at the selected location; and
d. optionally repeating steps b and c one or more times to partially or fully form the object, wherein for a repeated set of steps b and c, the selected location is the same as or different from a previous selected location and the optical image is the same as or different from a previous optical image.

Preferably the height dimension of the planar configuration of light substantially matches the maximum height dimension of the projected optical image in the volume at the selected location and the planar configuration at least fully overlaps the projected optical image in the volume at the selected location.

Preferably the light sheet illumination axis is orthogonal to the projection axis.

Preferably an optical image comprises a two-dimensional cross-sectional slice of an object to be printed and an optical image of a repeated step, when applicable, comprises a sequential two-dimensional cross-sectional slice of the object.

Preferably the optical image is oriented perpendicular to the projection axis along which the optical image is projected into the volume.

In accordance with another aspect of the present invention, there is provided a method for extending the reuse-printing lifetime of a photohardenable composition including a photoswitchable photoinitiator and a photohardenable resin component for reuse in volumetric 3D printing, the method comprising exposing a volume of a photohardenable composition including a photoswitchable photoinitiator and a photohardenable resin component to a projected optical image created by second excitation light and a light sheet generated with first excitation light such that the optical image and light sheet intersect, preferably in a common plane, at a selected location in the volume to induce polymerization or cross-linking of the composition at the selected location, wherein the light sheet is modified in one or more regions to reduce regions of the volume exposed only to first excitation light thereby reducing excitation of the photoswitchable photoinitiator in the photohardenable composition.

In accordance with another aspect of the present invention, there is provided a method for extending the reuse-printing lifetime of a photohardenable composition including a photoswitchable photoinitiator and a photohardenable resin component for reuse in volumetric 3D printing, the method comprising exposing a selected plane in a volume of the photohardenable composition to a projected optical image including a second excitation light and directing a controllably sized light sheet including a first excitation light along a light sheet illumination axis to the selected plane in the volume to intersect with the optical image in the selected plane to induce selective polymerization or cross-linking in the volume at the coplanar intersection of the projected optical image and controllably sized light sheet, wherein the height dimension of the light sheet is controlled such that the height dimension of the light sheet is less than the height dimension of the volume of the photohardenable composition through which it is passed and greater than or equal to the maximum height dimension of the optical image at the selected location in the volume, and wherein the controllably sized light sheet at least fully overlaps the projected optical image in the volume in the selected plane,
wherein regions of the volume exposed only to first excitation light is reduced for extending the reuse-printing lifetime of the photohardenable composition.

Optionally the method is repeated one or more times to partially or fully form an object, wherein when the method is repeated, the selected location is the same as or different from a previous selected location, and the optical image is the same as or different from a previous optical image.

Preferably the height dimension of the light sheet is controlled to substantially match the height dimension of the projected optical image in the volume in the selected plane and the light sheet at least fully overlaps the projected optical image in the volume in the selected plane.

Preferably an optical image comprises a two-dimensional cross-sectional slice of an object to be printed and an optical image of a repeated step, when applicable, comprises a sequential two-dimensional cross-sectional slice of the object.

Preferably the optical image is projected into the volume along a projection axis and the optical image is oriented perpendicular to the projection axis along which the optical image is projected into the volume.

Preferably the projection axis and light sheet illumination axis are orthogonal to each other.

A controllably sized light sheet preferably has a height dimension (e.g., vertical extent) adapted to match the height dimension (e.g., vertical extent) of the optical image with which it is directed to intersect in the volume.

In accordance with another aspect of the present invention, there is provided a method for extending the reuse-printing lifetime of a photohardenable composition including a photoswitchable photoinitiator, the method comprising:
a. providing a volume of the photohardenable composition including the photoswitchable photoinitiator and a photohardenable resin component, wherein the photoswitchable photoinitiator is activatable by exposure to first excitation light including a first wavelength and second excitation light including a second wavelength to induce a crosslinking or polymerization reaction in the photohardenable component, wherein the first and second wavelengths are different;
b. projecting an optical image generated with a second excitation light along a projection axis to a selected location in the volume, the optical image being oriented perpendicular to the projection axis, and directing a planar configuration of light generated with first excitation light along a light sheet illumination axis to the selected location in the volume such that it intersects with the optical image in a common plane, wherein the height dimension of the planar configuration of light is sized to be less than the height dimension of the volume through which the planar configuration is directed and greater than or equal to the maximum height dimension of the optical projection at the selected location in the volume, and wherein the planar configuration of light at least fully overlaps the projected optical image in the volume at the selected location; and
c. optionally repeating step b one or more times to partially or fully form the object, wherein for a repeated step b, the selected location is the same as or different from a previous selected location, the two-dimensional cross-sectional slice of the object is the same as a previous slice or is a sequential two-dimensional cross section slice of the object, and the height dimension of the planar configuration of light for a repeated step is sized to be less than the height dimension of the volume and greater than or equal to the maximum height dimension of the projected optical image in the volume at the selected location, and wherein the light sheet at least fully overlaps the projected optical image in the volume at the selected location for the repeated step.

Preferably the height dimension of the planar configuration of light substantially matches the maximum height dimension of the projected optical image at the selected location in the volume and the planar configuration fully overlaps the projected optical image in the volume at the selected location.

Preferably an optical image comprises a two-dimensional cross-sectional slice of an object to be printed and an optical image of a repeated step, when applicable, comprises a sequential two-dimensional cross-sectional slice of the object.

Preferably the optical image is oriented perpendicular to the projection axis along which the optical image is projected into the volume.

Preferably the projection axis and light sheet illumination axis are orthogonal to each other.

In methods in accordance with the present invention, an optical image may include two or more illuminated regions that are vertically separated from each other by one or more non-illuminated regions. In such case, a controllably sized light sheet can be configured to include two or more illuminated regions that are vertically separated from each other by one or more non-illuminated regions, wherein a vertically separated illuminated region of the light sheet is aligned to overlap one or more vertically separated illuminated regions of the optical image at the selected location and has a height dimension to at least overlap the maximum height dimension of the one or more vertically separated region or regions of the optical image with which it is aligned to intersect or overlap. When a vertically separated region of the light sheet is configured to align with and overlap a combination of two or more vertically separated illuminated regions of an optical image at the selected location, the height dimension of such illuminated light sheet region is determined based on the total maximum height of each illuminated optical image region it overlaps plus the height of the non-illuminated optical image regions therebetween. For example, when a vertically separated region of the light sheet is configured to overlap two or more vertically separated regions of an optical image, the height of such illuminated light sheet region preferably corresponds to the combined maximum height dimension of the illuminated optical image regions it overlaps and the height of any non-illuminated optical image regions therebetween.

Methods in accordance with the present invention can further include recovering photohardenable composition that is not solidified after removal of the printed objects for reuse, wherein the recovered photohardenable composition retains efficacy for reuse for printing additional objects.

In accordance with another aspect of the present invention there is provided a photohardenable composition including a photoswitchable photoinitiator and a photohardenable resin component that has been recovered from a method in accordance with the present invention wherein the composition retains efficacy for reuse for printing additional objects.

It is desirable for the composition to retain efficacy for reuse at least two times, preferably more.

In the methods described herein, the height or maximum height of an optical image or vertically separated illuminated of an optical image refers to the maximum height dimension of the optical image or vertically separated illuminated of the optical image region from its uppermost illuminated point to its lowermost illuminated point.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description, from the claims, and from practice of the invention disclosed herein.

### BRIEF DESCRIPTION OF THE DRAWINGS

In the drawings,

The attached figures are simplified representations presented for purposes of illustration only; the actual structures may differ in numerous respects, particularly including the relative scale of the articles depicted and aspects thereof.

FIG. 1 schematically represents the reactions of a photoswitchable photoinitiator upon exposure to first wavelength light.

FIG. 2 depicts a series of UV/visible absorption spectra which demonstrate the effect of continuous UV radiation on a representative photoswitchable photoinitiator.

FIG. 3A represents a perspective view of an example of light sheet illumination without the present invention. FIG. 3B represents a perspective view of an example of light sheet illumination in accordance with the present invention. FIG. 3C illustrates the object to be printed.

FIG. 4A represents a perspective view of an example of light sheet illumination without the present invention. FIG. 4B represents a perspective view of an example of light sheet illumination in accordance with the present invention. FIG. 4C illustrates a representation of the object 21 to be printed.

FIGS. 5, 6, and 7 illustrate embodiments of the present invention including a planar configuration of light or light sheet having a height dimension that is equivalent to the height dimension of the projected optical image in the volume at the selected location, wherein the planar configuration of light fully overlaps the projected optical image in the volume at the selected location.

FIGS. 8 and 9 illustrate embodiments of the present invention including an optical projection image comprising an optical image including vertically separated illuminated regions with non-illuminated regions between the illuminated regions, each such illuminated and non-illuminated region having a specific height dimension, and a planar configuration of light or light sheet including vertically separated illuminated regions with non-illuminated regions between the illuminated regions, each such illuminated and non-illuminated region having a height dimension that is equivalent to or the same as the corresponding region in the optical projection image and fully overlapping the corresponding region in the optical projection image. An alternative planar configuration of light or light sheet for use with the depicted optical projection image can comprise a singular light sheet having a height dimension that matches the height dimension of the composite optical projection image that fully overlaps the composite optical projection image in the volume at the selected location.

FIGS. 10 and 11 illustrate embodiments of the present invention including a planar configuration of light or light sheet having a height dimension that is larger than the height dimension of the optical projection image and smaller than the height of the volume and still fully overlapping the projected optical image in the volume at the selected location.

FIGS. 12 through 16 provide flow diagrams for examples of different methods for implementation of light sheet configurations that are suitable for use in the methods of the present invention.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present invention will be further described in the following detailed description.

The present invention includes methods for reducing photoexcitation of a dual-wavelength photoinitiator in volumetric printing including a volume of a photohardenable composition at locations in the volume at which intersection of two wavelengths does not occur; methods of three-dimensional (3D) volumetric printing including dual-wavelength photoexcitation of a photohardenable composition including a dual-wavelength photoinitiator, the method including photoexcitation by a controllably-size light sheet including a first wavelength and an optical projection including a second wavelength; and methods for extending the reuse-printing lifetime of a photohardenable composition including a dual-wavelength photoinitiator. The present invention also includes a photohardenable composition including a dual-wavelength photoinitiator with an improved reuse-printing lifetime. Preferably the photohardenable composition includes a dual-wavelength photoinitiator comprising a photoswitchable photoinitiator and a photohardenable resin component.

Reuse-printing lifetime can be measured by, for example, the number of times a photohardenable composition that has previously been included in a volume in which an object was printed can be reused for printing or recycled, e.g., the number of times a photohardenable composition that has been previously exposed to first wavelength light without being solidified into a printed object can be reused. For example, after a part or object is formed in a volume of a photohardenable composition and removed or separated from the volume, it is desirable to be able to reuse the remaining non-solidified photohardenable composition to print other parts.

The present invention includes directing a planar configuration of light or a light sheet including the first wavelength into a volume of a photohardenable composition including a photoswitchable photoinitiator which intersects with a projection of an optical image including the second wavelength to induce a crosslinking or polymerization reaction in the photohardenable composition and modulating the height dimension of the planar configuration of light or light sheet directed through the volume to reduce regions in the volume exposed only to the first wavelength where a crosslinking or polymerization reaction is not intended. Preferably exposure of the photohardenable composition to the first wavelength is reduced, more preferably substantially eliminated, in regions where intersection with the optical image including the second wavelength does not occur.

A controllably sized light sheet preferably has a height dimension (e.g., vertical extent) adapted to match the maximum height dimension (e.g., vertical extent) of the optical image with which it is directed to intersect at the selected location in the volume. A photoswitchable photoinitiator is activatable by exposure to a first excitation light including a first wavelength and a second excitation light including a second wavelength to induce a crosslinking or polymerization reaction in the photohardenable composition, wherein the first and second wavelengths are different.

The present invention is particularly advantageous with a first wavelength in a range for activating the photoswitchable photoinitiator to an active state. Such range can be, for example, from about 375 nm to about 460 nm.

The second wavelength is typically in the visible range of the spectrum, e.g., from about 470 nm to about 700 nm.

As discussed above, the first wavelength light will activate a photoswitchable photoinitiator. In the absence of the first wavelength, the second wavelength preferably will not have any effect on the photohardenable composition.

Exposure of the photohardenable composition including the photoswitchable photoinitiator will activate the photoswitchable photoinitiator exposed to the first wavelength for excitation by the second wavelength.

Active forms of the photoswitchable photoinitiator not involved in a crosslinking or polymerization reaction can also generate radicals which will the cause any number of possible outcome, such as oxygen consumption, polymerization, degradation of the photoswitchable photoinitiator, or other processes that reduce the possible reuse of the photohardenable composition for inclusion in another printing process.

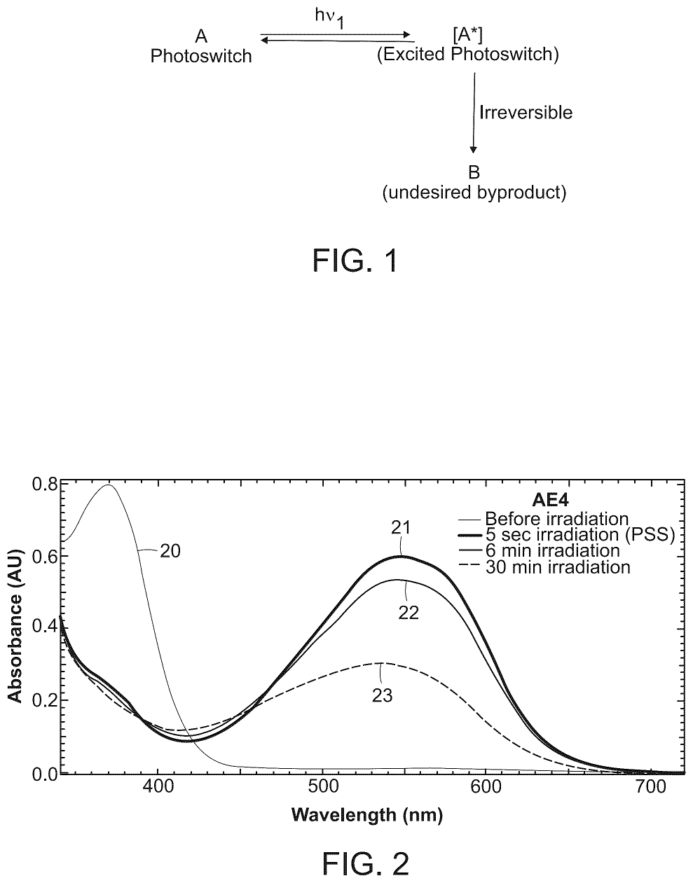

FIG. 1 provides an example of degradation reactions that a photoswitchable photoinitiator can undergo upon exposure to first wavelength light.

As depicted, a photoswitchable photoinitiator (depicted in the figure as “photoswitch”) A, when exposed to excitation light including a first wavelength of light hν₁, typically ultraviolet light, generates an excited state of the photoswitchable photoinitiator (depicted in the figure as “excited photoswitch”) [A*] which can revert to the unexcited state A upon continued exposure to the excitation light. Under exposure to the excitation light, the excited photoswitchable photoinitiator can also irreversibly generate undesired by-products B, reducing the population of photoswitchable photoinitiators.

FIG. 2 includes a series of UV/visible absorption spectra that demonstrate the effect of continuous UV irradiation on a photohardenable composition including a representative photoswitchable photoinitiator (designated AE4).

The series of ultraviolet (UV)/visible absorption spectra demonstrates the effect of continuous UV irradiation light in a FormCure (from Formlabs) on a representative photoswitchable photoinitiator. This simulates light sheet exposure. The significant change in the absorption spectrum, particularly notable in the visible regime, after 30 min under FormCure (Formlabs) irradiation (405 nm light) indicates significant degradation of the photoswitchable photoinitiator occurs. This degradation is undesirable for successful repeated usage of a photohardenable composition including a photoswitchable photoinitiator in methods for printing three-dimensional objects.

Following is a description of the photohardenable composition including the designated photoswitchable photoinitiator with which the spectra were acquired measurement of the depicted spectra.

### Preparation of Photoswitchable Photoinitiator AE4

The photoswitchable photoinitiator designated as AE4 was prepared substantially as described in the Example section of International Application No. PCT/US2023/022172 of Quadratic 3D, Inc. filed May 13, 2023 for a dual-wavelength photoswitchable photoinitiator having the same designation.

### Preparation of Base Resin

A 100-mL round bottom flask containing a magnetic stir bar was charged with 10.0 g of thixotrope (Crystasense HP-5, Croda). To this flask was then added 50.0 g of N,N-dimethylacrylamide (DMAA, Rahn) via syringe. The flask was sealed with a rubber septum and a 1-in 22G needle was inserted for venting. The flask was placed on a preheated (105° C.) aluminum heating block and the mixture was stirred at 250-300 rpm until the thixotrope fully dissolved (10-15 min). Next, a 0.6 gallon polypropylene pail equipped with polypropylene lid was charged with 50.0 g DMAA via syringe. To this pail was then added 200 g of Genomer 4259 (Rahn) and 650 g of Genomer 4247 (Rahn) via large-bore syringe. The contents of the pail were speedmixed (DAC 2800-1000, Flacktek) at 1100 rpm for 1 min. The HP-5 solution was then poured into the pail and the contents of the pail were speedmixed at 1100 rpm for a further 1 min.

### Preparation of Test Resin Including Photoswitchable Photoinitiator AE4

A stock solution was prepared by dissolving photoswitchable photoinitiator AE4 in N,N-dimethylacrylamide (DMAA, Rahn) in a 4 mL amber vial to get a final concentration of 1.00 mg/g of analyte in DMAA. To a 40 mL amber vial containing 29.4 g of Base Resin (described above) was then added 0.60 g of the AE4 stock solution to create a resin containing 20 parts per million (by mass) of AE4. This mixture was speedmixed (DAC 2800-1000, Flacktek) at 3500 rpm for 1 min and transferred to a 1 cm plastic cuvette. The cuvette was capped and centrifuged at 4000 rpm for 3 min to remove trapped air bubbles.

### Measurement of Absorption Spectra Before and After Continuous Form Cure Irradiation

The absorption spectra shown in FIG. 2 were acquired on a Shimadzu UV-1900 UV/Vis spectrophotometer using a 1 cm cuvette containing Test Resin (prepared as described above). Irradiation was performed using a Form Cure apparatus (purchased from Formlabs) with 405 nm light. First, a spectrum 20 was acquired with no external irradiation. Next, the cuvette was irradiated in the Form Cure for 5 seconds, then another spectrum 21 was acquired. These two operations were repeated after 10 seconds (total irradiation time), 6 minutes, at which time spectrum 22 was acquired, and 30 minutes, at which time spectrum 23 was acquired, to produce the spectra shown in FIG. 2. The photostationary state (PSS) was reached within 5 seconds, as indicated the equivalence of the 5 and 10 second spectra (the former is not shown).

These results are representative of light sheet exposure of a photohardenable composition including a photoswitchable photoinitiator. The 50% decrease in absorbance at 546 nm after 30 min under mild FormCure irradiation indicates significant degradation of the photoswitchable photoinitiator. This degradation is undesirable for successful repeated usage of this photohardenable composition.

The present invention includes reducing the exposure of a photohardenable composition including a photoswitchable photoinitiator to a first wavelength in regions of the photohardenable composition in which the second wavelength is not projected for inducing a crosslinking or polymerization reaction.

After the printing process, the printed parts that are removed from the photohardenable composition. This leaves behind the photohardenable composition which was not converted into the printed object.

It would be highly advantageous to be able to reuse this unconverted photohardenable composition for further printing.

By so reducing the exposure of the photohardenable composition including a photoswitchable photoinitiator to a first wavelength in regions of the photohardenable composition in which the second wavelength is not projected, the generation of undesired radicals which can limit reuse of the photohardenable composition can be reduced.

This invention includes reducing, and preferably minimizing, unintended dosage of shorter first wavelength light during the printing process to regions that do not require this dosage to form the desired 3D part, therefore yielding printed objects, that after removal from the volume, leaves behind remaining photohardenable composition which is more amenable to recycling and reuse.

The present invention includes methods for reducing photoexcitation of a photoswitchable photoinitiator in volumetric printing including a volume of a photohardenable composition at locations in the volume at which intersection of two wavelengths does not occur; methods of 3D volumetric printing including dual-wavelength photoexcitation of a photohardenable composition including a dual-wavelength photoinitiator, the method including photoexcitation by a controllably-size light sheet including a first wavelength and an optical projection including a second wavelength. The present invention also includes a photohardenable composition including a dual-wavelength photoinitiator with an improved reuse-printing lifetime. Preferably the photohardenable composition includes a dual-wavelength photoinitiator comprising a photoswitchable photoinitiator and a photohardenable resin component.

In accordance with one aspect of the present invention, there is provided a 3D printing method, the method comprising exposing a volume of a photohardenable composition including a photoswitchable photoinitiator and a photohardenable resin component to a projected optical image created by second excitation light and a light sheet generated with first excitation light such that the optical image and light sheet intersect in a common plane at a selected location in the volume to induce polymerization or cross-linking of the composition at the selected location, wherein the size and configuration of the light sheet intersecting with the optical image is controlled to reduce regions of the volume exposed only to first excitation light thereby reducing excitation of the photoswitchable photoinitiator in the photohardenable composition.

Reducing regions of the volume exposed only to first excitation light can advantageously extend the reuse-printing lifetime of a photohardenable composition including a photoswitchable photoinitiator.

In accordance with another aspect of the present invention, there is provided a method of volumetric printing with reduced photoexcitation of a photoswitchable photoinitiator included in the printing volume, the method comprising:
a. providing a volume of a photohardenable composition including the photoswitchable photoinitiator and a photohardenable resin component, wherein the photoswitchable photoinitiator is activatable by exposure to a first excitation light including a first wavelength and a second excitation light including a second wavelength to induce a crosslinking or polymerization reaction in the photohardenable component, wherein the first and second wavelengths are different;
b. projecting an optical image generated with the second excitation light along a projection axis to a selected location in the volume, wherein the optical image is oriented perpendicular to the projection axis;
c. generating a planar configuration of light including the first excitation light and directing the planar configuration of light along a light sheet illumination axis through the volume such that the optical image and the planar configuration of light intersect at the selected location in a common plane, wherein the planar configuration of light has a height dimension that is controlled to be less than the height dimension of the volume through which the light sheet is passed and greater than or equal to the height dimension of the projected optical image in the volume at the selected location, and wherein the planar configuration of light at least fully overlaps the projected optical image in the volume at the selected location; and
d. optionally repeating steps b and c one or more times to partially or fully form the object, wherein for a repeated set of steps b and c, the selected location is the same as or different from a previous selected location and the optical image is the same as or different from a previous optical image.

Preferably the height dimension of the planar configuration of light substantially matches the height dimension of the projected optical image in the volume at the selected location, and wherein the planar configuration of light fully overlaps the projected optical image in the volume at the selected location.

Preferably the light sheet illumination axis is orthogonal to the projection axis.

Preferably an optical image comprises a two-dimensional cross-sectional slice of an object to be printed and an optical image of a repeated step comprises a sequential two-dimensional cross-sectional slice of the object and the planar configuration of light at least fully overlaps the projected optical image in the volume at the selected location of the repeated step.

Preferably the optical image is oriented perpendicular to the projection axis along which the optical image is projected into the volume.

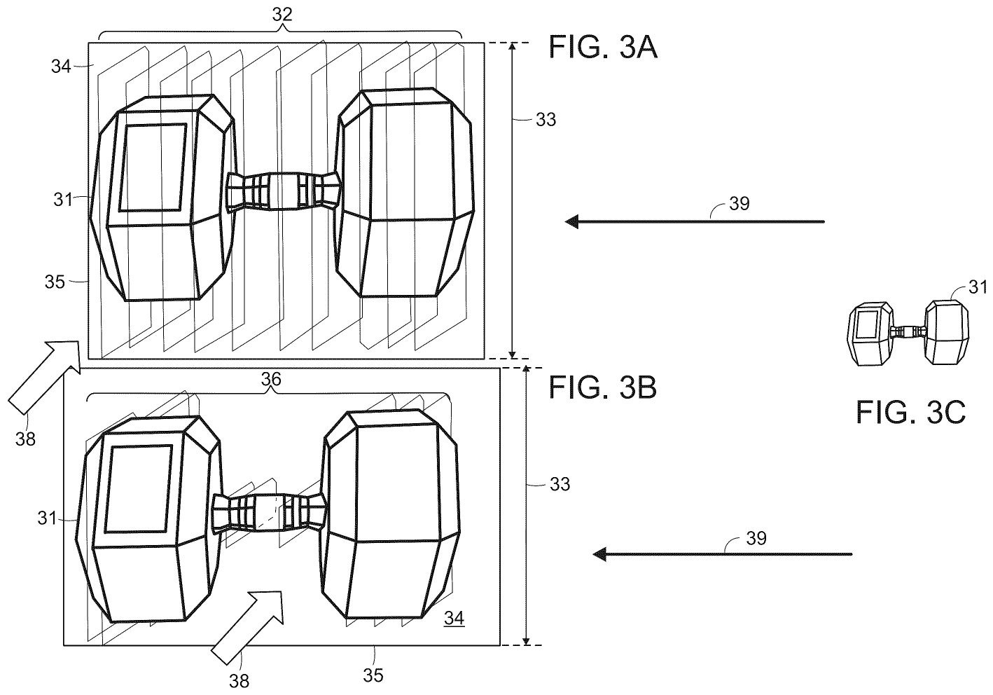

FIG. 3A illustrates a perspective view of an example of a representation of volumetric printing an object 31 including light sheet technology without the invention, wherein the light sheets 32 sequentially directed through the volume of the photohardenable composition 34 during printing extends through the full height 33 (vertical extent) of the volume in a container 35. The direction in which a light sheet is directed into the volume is indicated by arrow 38. The direction in which an optical image is projected into the volume is indicated by arrow 39.

FIG. 3B illustrates a perspective view of an example of a representation of printing methods in accordance with the present invention including an adapted planar configuration of light or light sheet including a first wavelength wherein a series of planar configurations of light or light sheets 36 are sequentially directed through the volume of the photohardenable composition 34 in the container 35. Each planar configuration of light or light sheet is controllably sized to reduce the height or vertical dimension of the light sheet to match the height (e.g., vertical dimension) of the projected optical image in the volume of the photohardenable composition. In the depicted example, the height (e.g., vertical extent) of the planar configuration of light or light sheet directed through the volume for each projected optical image is substantially the same as, and aligned to intersect with, the corresponding two dimensional cross-sectional plane of the optical image (not shown) at a selected location. Such height is less than the full height 33 of the volume of the photohardenable composition in the container. The direction in which a light sheet is directed into the volume is indicated by arrow 38. The direction in which an optical image is projected into the volume is indicated by arrow 39.

FIG. 3C illustrates a representation of the object 31 to be printed.

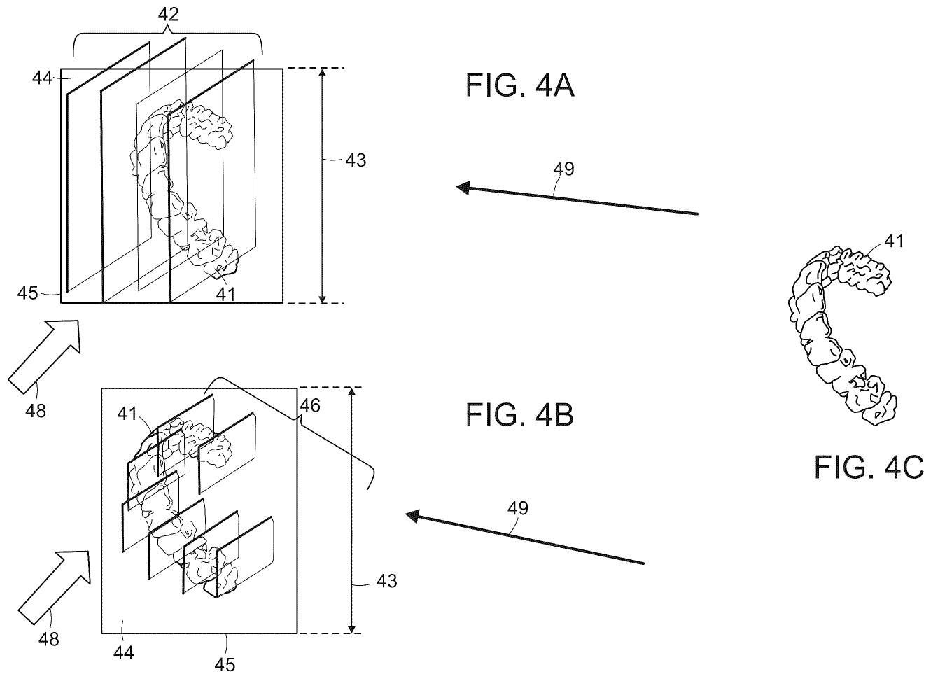

FIGS. 4A and 4B show an example of a representation of a similar comparison for the printing of a dental appliance. FIG. 4A illustrates a perspective view of an example of volumetric printing including light sheet technology wherein a series of light sheets 42 are sequentially directed through the volume of the photohardenable composition 44 included a container 45 extends through the full height 43 (vertical extent) of the volume. FIG. 4B illustrates a perspective view of an example of printing in accordance with the present invention including a planar configuration of light or light sheet including a first wavelength 46 wherein a series of planar configurations of light or light sheet 46 are sequentially directed through the volume of the photohardenable composition. Each planar configuration of light or light sheet is controllably sized to reduce the height or vertical dimension of the light sheet to match the height (e.g., vertical dimension) of the projected optical image in the volume of the photohardenable composition. In the depicted embodiment, the height (e.g., vertical extent) of the planar configuration of light or light sheet directed through the volume for each projected optical image is substantially less than the full height of the volume 43 through which it is directed through the volume along the light sheet illumination axis and greater than or equal to the height (e.g., vertical extent) of the illuminated optical image and aligned to intersect therewith. The direction in which a light sheet is directed into the volume is indicated by arrow 48. The direction in which an optical image is projected into the volume is indicated by arrow 49. FIG. 4C illustrates a representation of the object 41 to be printed. (Full height of the volume refers to the height dimension from the bottom to top of the volume in the container.)

In the examples shown in FIGS. 3A, 3B, 4A, and 4B, an optical image corresponding to a cross-sectional plane of the object (not shown) is projected into the volume along an optical image projection axis, the optical image being perpendicular to its projection axis. A light sheet is directed into the volume along a light sheet illumination axis to intersect with the optical image. FIGS. 3B and 4B depict embodiments of the present invention including reduced exposure of the photohardenable composition including a photoswitchable photoinitiator to first wavelength light in regions of the composition in which intersection with second wavelength light does not occur.

In accordance with another aspect of the present invention, there is provided a method for extending the reuse-printing lifetime of a photohardenable composition including a photoswitchable photoinitiator for reuse in volumetric 3D printing, the method comprising exposing a volume of a photohardenable composition including a photoswitchable photoinitiator and a photohardenable resin component to a projected optical image created by second excitation light and a light sheet generated with first excitation light such that the optical image and light sheet intersect, preferably in a common plane, at a selected location in the volume to induce polymerization or cross-linking of the composition at the selected location, wherein the light sheet is modified in one or more regions to reduce regions of the volume exposed only to first excitation light thereby reducing excitation of the photoswitchable photoinitiator in the photohardenable composition.

In accordance with another aspect of the present invention, there is provided a method for extending the reuse-printing lifetime of a photohardenable composition including a photoswitchable photoinitiator and a photohardenable resin component for reuse in volumetric 3D printing, the method comprising exposing a selected plane in a volume of the photohardenable composition to a projected optical image including a second excitation light and directing a controllably sized light sheet including a first excitation light along a light sheet illumination axis to the selected plane in the volume to intersect with the optical image in the selected plane to induce selective polymerization or cross-linking in the volume at the coplanar intersection of the projected optical image created and controllably sized light sheet, wherein the height dimension of the light sheet that is directed into the volume along the light sheet illumination axis is controlled such that height dimension of the light sheet is less than the height dimension of the volume of the photohardenable composition through which it is passed and greater than or equal to the height dimension of the projected optical image in the volume in the selected plane, and wherein the light sheet at least fully overlaps the projected optical image in the volume in the selected plane.
wherein regions of the volume exposed only to first excitation light is reduced for extending the reuse-printing lifetime of the photohardenable composition for reuse.

Optionally the method is repeated one or more times to partially or fully form an object, wherein when the method is repeated, the selected location is the same as or different from a previous selected location, the optical image is the same as or different from a previous optical image.

Preferably the height dimension of the light sheet is controlled to substantially match the height dimension of the projected optical image in the volume in the selected plane and the light sheet fully overlaps the projected optical image in the volume at the selected location.

Preferably an optical image comprises a two-dimensional cross-sectional slice of an object to be printed and an optical image of a repeated step comprises a sequential two-dimensional cross-sectional slice of the object.

In accordance with another aspect of the present invention, there is provided a method for extending the reuse-printing lifetime of a photohardenable composition including a photoswitchable photoinitiator, the method comprising:
a. providing a volume of the photohardenable composition including the photoswitchable photoinitiator and a photohardenable resin component, wherein the photoswitchable photoinitiator is activatable by exposure to first excitation light including a first wavelength and second excitation light including a second wavelength to induce a crosslinking or polymerization reaction in the photohardenable component, wherein the first and second wavelengths are different;
b. projecting an optical image generated with a second excitation light along a projection axis to a selected location in the volume, the optical image being oriented perpendicular to the projection axis, and directing a planar configuration of light generated with first excitation light along an light sheet illumination axis to the selected location in the volume such that it intersects with the optical image in a common plane, wherein the height dimension of the planar configuration of light is sized to be less than the height dimension of the volume through which the planar configuration of light is directed and greater than or equal to the height dimension of the projected optical image at the selected location in the volume, and wherein the planar configuration of light at least fully overlaps the projected optical image in the volume at the selected location; and
c. optionally repeating step b one or more times to partially or fully form the object, wherein for a repeated step b, the selected location is the same as or different from a previous selected location, the two-dimensional cross-sectional slice of the object is the same as a previous slice or is a sequential two-dimensional cross section slice of the object, and the height dimension of the planar configuration of light for a repeated step is sized to be less than the height dimension of the volume along the light sheet illumination axis and greater than or equal to the height dimension of the projected optical image in the volume at the selected location, and wherein the light sheet at least fully overlaps the projected optical image in the volume at the selected location for the repeated step.

Preferably the height dimension of the planar configuration of light substantially matches the height dimension of the projected optical image at the selected location in the volume and the planar configuration of light fully overlaps the projected optical image in the volume at the selected location.

Preferably an optical image comprises a two-dimensional cross-sectional slice of an object to be printed and an optical image of a repeated step, when applicable, comprises a sequential two-dimensional cross-sectional slice of the object.

Reducing exposure of the photohardenable composition to first wavelength in methods described herein preferably includes controlling or modulating the size of the planar configuration of light or a light sheet directed through the photohardenable composition for intersection with light including the second wavelength for inducing a crosslinking or polymerization reaction in the volume.

Methods in accordance with the present invention can further include recovering photohardenable composition that is not solidified during printing or formation of one or more objects after removal of the printed object(s) for reuse, wherein the recovered photohardenable composition retains efficacy for reuse for printing additional objects.

Methods in accordance with the present invention preferably display non-Newtonian rheological behavior for facilitating forming an object that is fully suspended in the volume of the photohardenable composition during printing or formation.

Configurations of such controlled or sized planar configurations of light or light sheets for inclusion in the methods of the present invention include, but are not limited to, the following.

Planar configuration of light or light sheet can have a height dimension sized to substantially match the full height of the optical image (e.g., optical image projection slice) projected for intersection with the planar configurations of light or the light sheet, with the planar configurations of light or light sheets being positioned to align with and overlap the optical image for intersection.

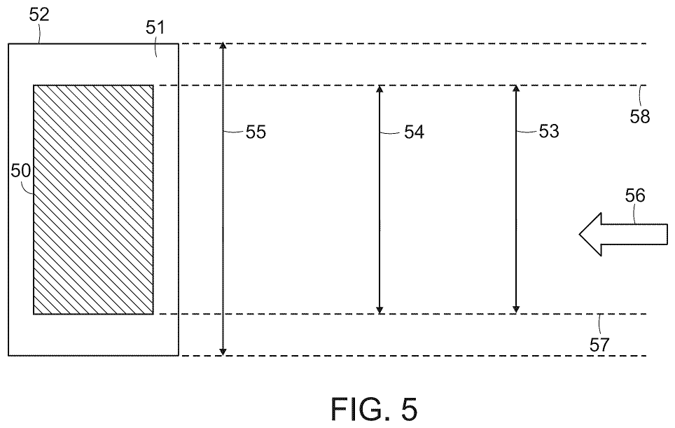

FIG. 5 illustrates a side view of the illuminated region of an optical image projection slice 50 projected into a volume of a photohardenable composition 51 included in a container 52 that identifies the height 53 of the light sheet (not shown) that substantially matches the height 54 of an optical projection image, the distance between the lowermost point 57 and the uppermost point 58 of the optical image 50. The full height 55 of the volume is also identified. The light sheet projection axis 56 is also shown,

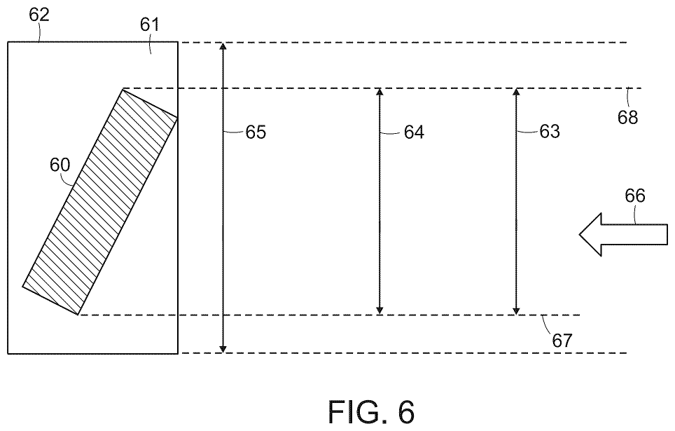

FIG. 6 illustrates a side view of the illuminated region of an optical image 60 projected into a volume of a photohardenable composition 61 included in a container 62 The height 63 of the light sheet (not shown) substantially matches the height dimension of the optical projection image 64, shown as the distance between the lowermost point 67 and the uppermost point 68 of the optical image 60. The full height 65 of the volume is also identified. The light sheet projection axis 66 is also shown.

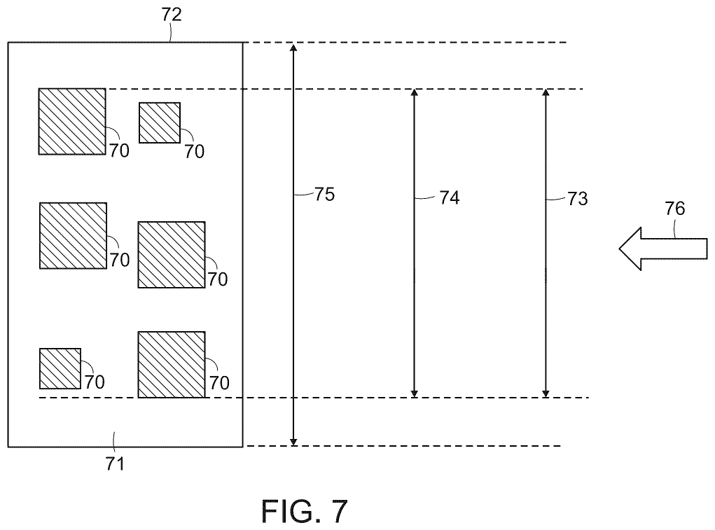

FIG. 7 illustrates a side view of an optical image including more than one illuminated region 70 projected into a volume of a photohardenable composition 71 included in a container 72. The height 73 of the light sheet (not shown) substantially matches the height dimension of the optical projection image 74, shown as the distance between the lowermost point and uppermost point of the combination of optical images. The full height 75 of the volume is also identified. The light sheet projection axis 76 is also shown. The illuminated regions 70 can be of various shapes and sizes typically based on the optical image and can be separated by non-illuminated regions that can be of various shapes and sizes.

Planar configurations of light or light sheets can include two or more vertically separated bands of light or illuminated regions spaced to intersect with the vertically separated or spaced illuminated regions of an optical image including vertically separated or spaced illuminated regions, with the vertically separated bands or regions of a planar configuration of light or light sheets being positioned to align with and overlap the vertically separated or spaced illuminated regions of the optical image.

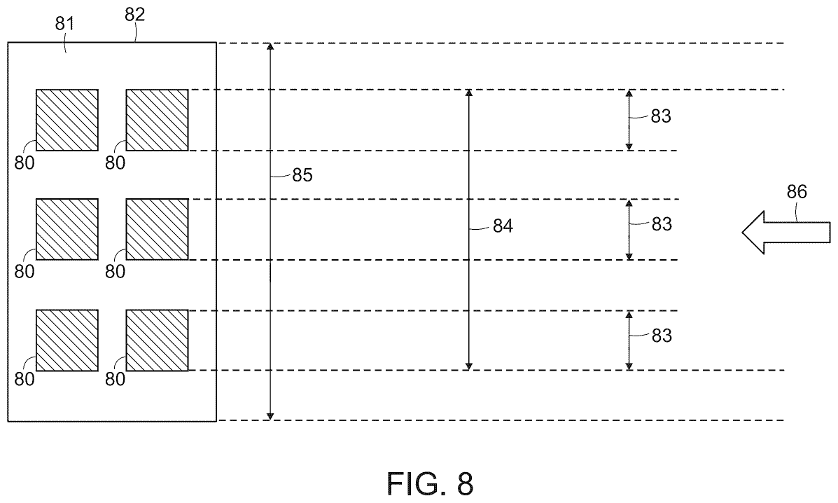

FIG. 8 illustrates a side view of an optical image including more than one illuminated region 80 projected into a volume of a photohardenable composition 81 included in a container 82. The depicted optical image includes vertically separated or spaced illuminated regions. The total height dimension of the optical projection image 84 is shown. The figure also identifies planar configurations of light or light sheets (not shown) that include separated illumination regions having a height dimension 83 sized and spaced to intersect with the vertically separated or spaced illuminated regions of the optical image including vertically separated or space regions. The full height 85 of the volume is also identified. The light sheet projection axis 86 is also shown. The illuminated regions 80 can be of various shapes and sizes typically based on the optical image and can be separated by non-illuminated regions that can be of various shapes and sizes. Alternatively, a planar configuration of light or light sheet for use with the depicted optical projection image can comprise a singular light sheet having a height dimension that matches the full height dimension of the composite optical projection image 84, as discussed above, that overlaps the full height of the composite optical projection image in the volume at the selected location.

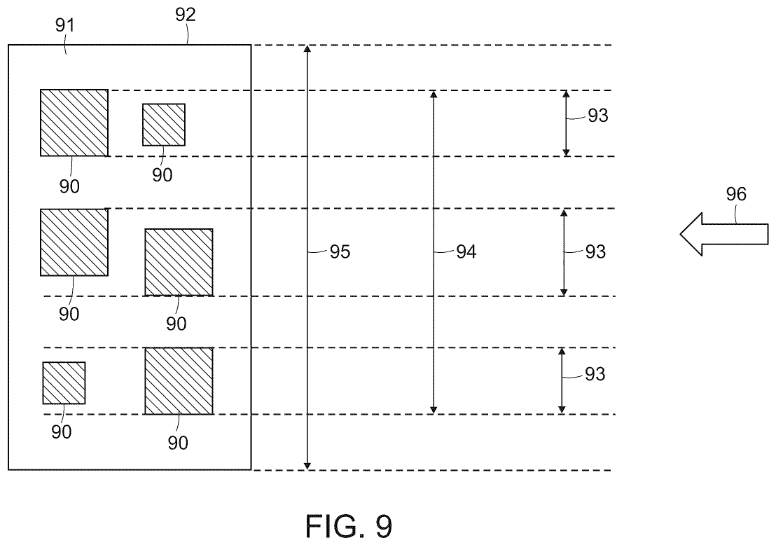

FIG. 9 illustrates a side view of an optical image including more than one illuminated region 90 projected into a volume of a photohardenable composition 91 included in a container 92. The depicted optical image includes vertically separated or spaced illuminated regions. The total height dimension of the optical projection image 94 is shown. The figure also identifies planar configurations of light or light sheets (not shown) that include separated illumination regions having a height dimension 93 sized and aligned to overlap with the vertically separated or spaced illuminated regions of the optical image including vertically separated or space regions. The full height 95 of the volume is also identified. The light sheet projection axis 96 is also shown. The illuminated regions 90 can be of various shapes and sizes typically based on the optical image and can be separated by non-illuminated regions that can be of various shapes and sizes.

Alternatively, a planar configuration of light or light sheet for use with the depicted optical projection image can comprise a singular light sheet having a height dimension that matches the full height dimension of the composite optical projection image 94, as discussed above, that overlaps the full height of the composite optical projection image in the volume at the selected location.

Planar configurations of light or light sheets that have a height dimension from the top or bottom of the volume of the photohardenable composition to the most distant opposite point of the optical image projected into the volume, wherein the height dimension is greater than the full height of the optical image (e.g., optical image projection slice) but less than the full height dimension of the volume of the photohardenable composition and is aligned to fully overlap the optical image in the volume

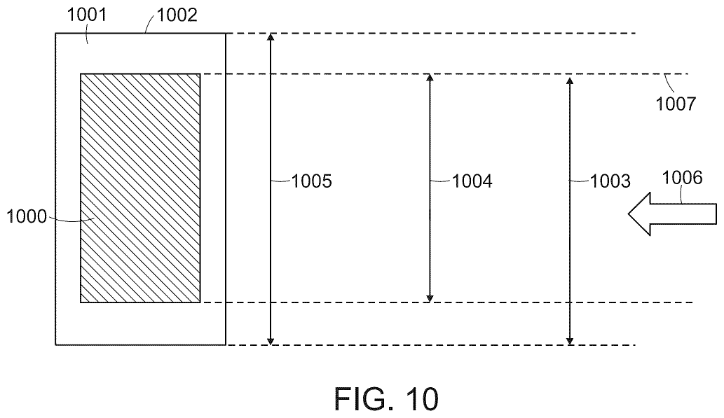

FIG. 10 illustrates a side view of the illuminated region of an optical image projection slice 1000 projected into a volume of a photohardenable composition 1001 included in a container 1002. The height 1003 of the light sheet (not shown) from the bottom of the volume to the uppermost point 1007 of the optical projection image is also shown. The height dimension 1004 of the optical image is indicated. The full height 1005 of the volume and the light sheet projection axis 1006 are also shown. The height dimension indicated for the light sheet is less than the height dimension of the volume and greater than the height dimension of the projected optical image.

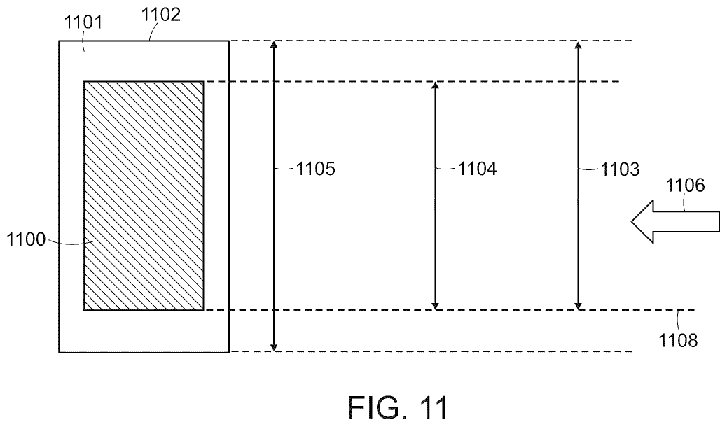

FIG. 11 illustrates a side view of the illuminated region of an optical image projection slice 1100 projected into a volume of a photohardenable composition 1101 included in a container 1102, The height 1103 of the light sheet (not shown) from the top of the volume to the lowermost point 1108 of the optical projection image is also shown. The height dimension 1104 of the optical image is indicated. The full height 1105 of the volume and the light sheet projection axis 1106 is also shown. The height dimension indicated for the light sheet is less than the height dimension of the volume and greater than the height dimension of the projected optical image.

Examples of methods for generating such controlled or sized planar configurations of light or light sheets include use of a spatial light modulator such as a DMD, LCOS panel, LCD panel, grating light valve, micro led array, or physical mask. Based on information about the full height of the optical image (e.g., the full vertical illuminated extent of the projection slice), a corresponding planar configuration of light or light sheets having a height dimension (e.g., the full vertical extent of the light sheet) sized to substantially match the height dimension of the optical image can be projected by turning off/on the corresponding spatial light modulator pixels, or in the case of a two dimensional spatial light modulator, turning off/on the corresponding spatial light modulator pixels in one column or row of the spatial light modulator. If it is desired that the controlled or sized planar configuration of light or light sheet, be sized to have a height (vertical extent) from the top or bottom of the volume to the most remote point of the optical image, the desired height can be obtained by turning off/on the corresponding spatial light modulator pixels. Alternatively, when an optical image includes one or more vertically separated or spaced regions, based on information about the height (e.g., vertical extent) of the one or more illuminated regions of the optical image, the corresponding one or more bands of the planar configurations of light or light sheet can be projected by turning off/on the corresponding spatial light modulator pixels. In the above cases, the light source powering the light sheet can be continuously on or otherwise modulated such that the light source is on at least when actively printing a slice, and the state of each of the spatial light modulator pixels controls whether light at a certain vertical position contributes toward forming the light sheet. To print an object, the light sheet is preferably coplanar with the focal plane of the projected optical image (e.g., the optical image projection slice). It is desirable for this coplanar arrangement to be able to move relative to the container. In the case of a one-dimensional spatial light modulator (grating light valve, ID micro led array), coplanarity and movement relative to the container may be accomplished, for example, by physically moving two of the three of projection slice, light sheet, and container. In the case of a two-dimensional spatial light modulator (DMD, LCOS, LCD, 2D micro led array), motion of the light sheet may be effected by turning on the corresponding pixels within successive rows or columns of the spatial light modulator. In this case, coplanarity may be accomplished for example by physically moving one of the two of projection slice and container.

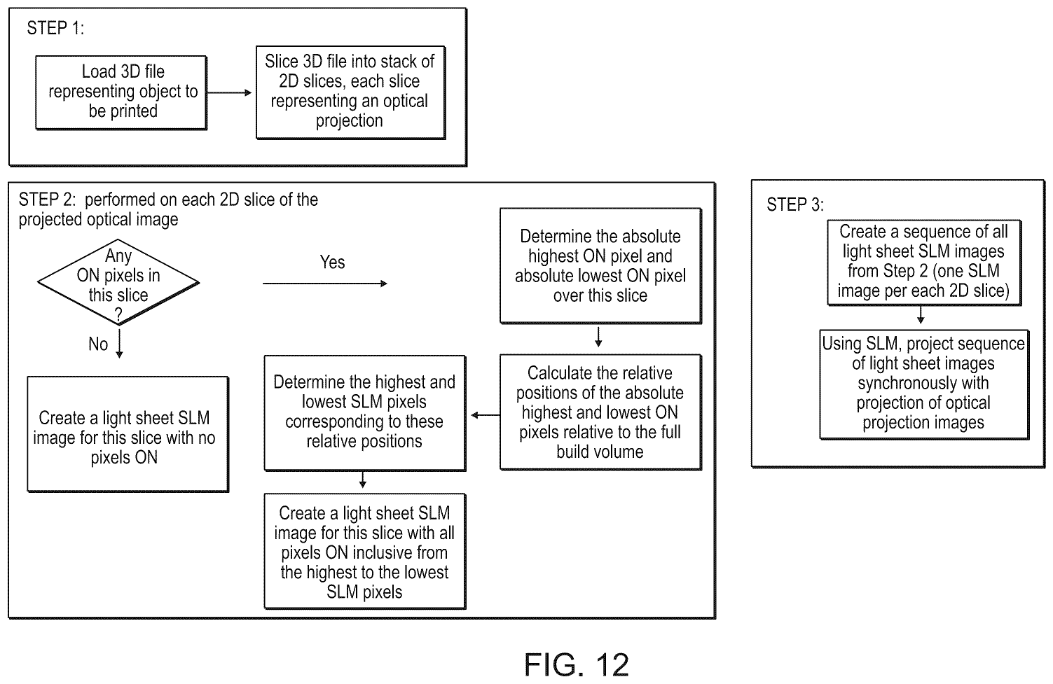

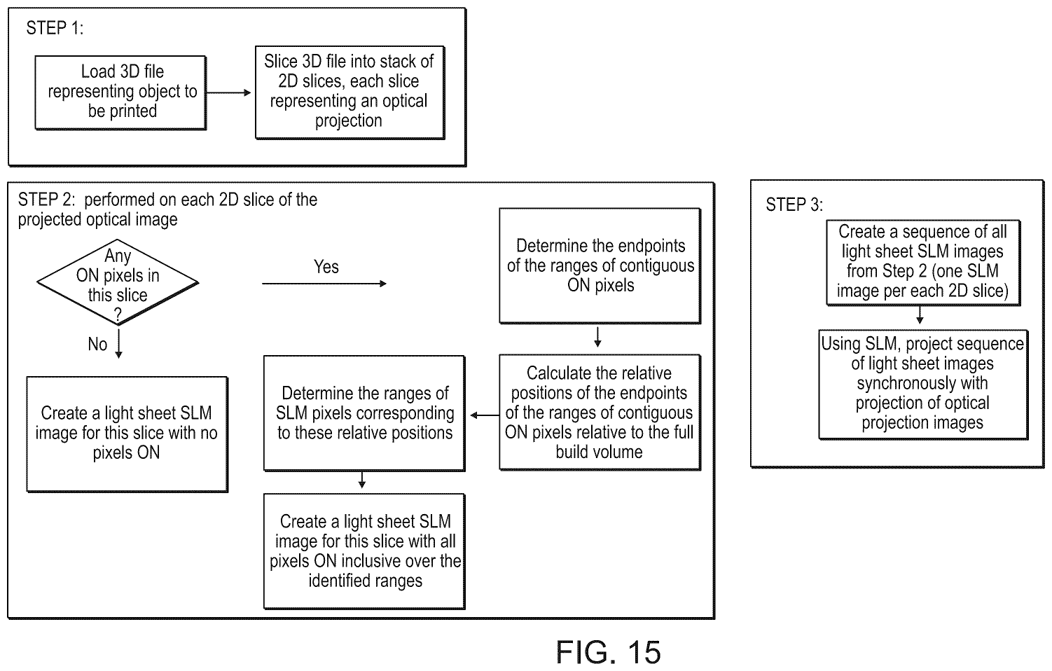

FIGS. 12 and 15 provide flow charts for examples of methods for modifying the size and/or configuration of a light sheet using a Spatial Light Modifier (SLM).

FIG. 12 provides a flow chart for an example of an embodiment including generating a light sheet with a height that is less than the full height of the volume and using an SLM to project the light sheet.

The depicted example includes three steps.

A first step that includes loading a 3D file representing object to be printed and slicing the 3D file into stack of 2D slices, each slice representing an optical projection.

A second step that is performed on each 2D slice of the projected optical image includes determining if there are any ON pixels in the slice. If there are no ON pixels in the slice, a light sheet SLM image is created for the slice with no pixels ON. In other words, no SLM light sheet is projected for the slice. If there are any ON pixels in the given slice, the position of the uppermost ON pixel in the height dimension of the slice and the position of the lowermost ON pixel in the slice in the height dimension of the slice are determined and the relative positions thereof are calculated relative to the full height of build volume (e.g., the full height of the volume of the photohardenable composition in the container) through which the light sheet is projected. Next the corresponding highest and lowest SLM pixels are determined relative to these positions, and a light sheet SLM image is created for this slice with all pixels ON inclusive from the highest to the lowest SML pixels.

A third step includes creating a sequence of all light sheet SLM images from the second step that correspond to each 2D slice and using the SLM to project the sequence of the light sheet images synchronously with the projection of the optical image slices.

In this example, the height of the SLM generated light sheet corresponds to the maximum height of the optical image height across the width of the slice and the portions of the volume above and below the optical image slice are not irradiated with the light sheet light for the slice, thereby reducing the exposure of the photohardenable composition to only light sheet light.

FIG. 15 provides a flow chart for an example of an embodiment including generating a light sheet with separated illuminated regions and using an SLM to project the light sheet.

The depicted example includes three steps.

A first step that includes loading a 3D file representing object to be printed and slicing the 3D file into stack of 2D slices, each slice representing an optical projection.

A second step that is performed on each 2D slice of the projected optical image includes determining if there are any ON pixels in the slice. If there are no ON pixels in the slice, a light sheet SLM image is created for the slice with no pixels ON. In other words, no SLM light sheet is projected for the slice. For the separated illuminated regions of the slice, the positions of the uppermost ON pixel in the height dimension of each illuminated region of the slice and the positions of the lowermost ON pixel in each illuminated region of the slice in the height dimension of the slice are determined and the relative positions thereof are calculated relative to the full height of build volume (e.g., the full height of the volume of the photohardenable composition in the container) through which the light sheet is projected. Next the corresponding ranges of SLM pixels corresponding to the highest and lowest SLM pixels of each illuminated region of the optical image are determined relative to these positions, and a light sheet SLM image is created for this slice with pixels ON inclusive from the highest to the lowest SML pixels for each of the ranges identified for the separated regions.

A third step includes creating a sequence of all light sheet SLM images from the second step that correspond to each 2D slice and using the SLM to project the sequence of the light sheet images synchronously with the projection of the optical image slices.

In this example, an SLM light sheet is generated that includes separated illuminated light sheet regions that corresponds to the maximum height for each of the separated illuminated regions of the optical image across the width of the slice and the portions of the volume between illuminated regions and above and below the overall the top and bottom of the overall optical image slice are not irradiated with light sheet light for the slice thereby reducing the exposure of the photohardenable composition to only light sheet light.

Another example of a method for generating the controlled or sized light sheet includes use of a scanner such as a galvanometer, polygon scanner, or MEMS scanner, in which the scanner is engaging in a scanning motion which includes the capability to access the full vertical extent of the optical projection area. Based on information about the full vertical illuminated extent of an optical image (e.g., the optical image projection slice) the desired corresponding height (e.g., vertical extent) of the planar configuration of light or light sheet can be projected by turning on or otherwise enabling the light source only when the scanner angular position is such that this region of the light sheet is illuminated and turning the light source off or otherwise disabling the light source at all other times. Alternatively, when an optical image includes one or more vertically separated or spaced regions, based on information about the height (e.g., vertical extent) of the one or more illuminated regions of the optical image, the corresponding one or more bands of the planar configurations of light or light sheet can be projected by turning on or otherwise enabling the light source only when the scanner angular position is such that these one or more than one regions are illuminated and turning the light source off or otherwise disabling the light source at all other times. This method includes a signal such as an electrical signal that indicates the angular position of the scanner. Such a signal might be provided for example by the scanner drive electronics or by an internal or external optical sensor that detects the position of the scanner. This method further includes an ability to turn the light source on and off or otherwise enabling or disabling the light source in a custom sequence at a maximum time rate determined by the scan velocity of the scanner in use. Such a method might be provided for example by an input signal to the light source drive electronics or by control of an internal or external shutter placed at any location between the light source and the container. A shutter may for example involve physical motion of a beam blocking material (mechanical shutter) or alteration of the optical transmission of a material (liquid crystal shutter). This method preferably further includes a method of synchronization between the signal indicating the angular position of the scanner and the on/off or other enabling/disabling control of the light source. This method of synchronization may be software based, hardware based, or software and hardware based. This method will work with any type of scanner, regardless of whether it is a rotary type (i.e., polygon scanner) or deflection type (i.e., galvanometer or MEMS scanner), and whether it is a resonant (free running) type or a point to point (addressable) type.

A further example of a method for generating a controlled or sized planar configuration of light or light sheet includes use of an addressable scanner such as a galvanometer or MEMS scanner. Based on information about the full height (e.g., vertical illuminated extent) of the optical image (e.g., optical image projection slice) being projected, only those scanner angular positions are addressed such that the corresponding desired configuration of the light sheet is illuminated, and all other angular positions are not addressed. In this case, the light source powering the light sheet can be continuously on or otherwise modulated such that the light source is on at least when actively printing a slice.

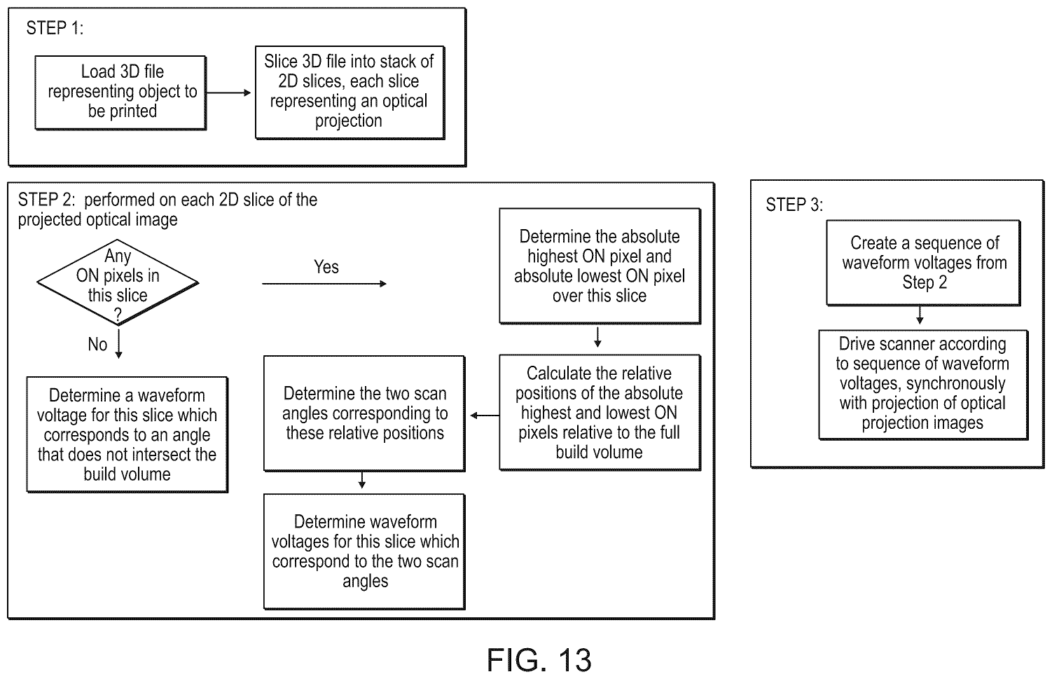

FIG. 13 provides a flow chart for an example of an embodiment including generating a light sheet with a height that is less than the full height of the volume and using an addressable scanner with no laser control to project the light sheet.

The depicted example includes three steps.

A first step that includes loading a 3D file representing object to be printed and slicing the 3D file into stack of 2D slices, each slice representing an optical projection.

A second step that is performed on each 2D slice of the projected optical image includes determining if there are any ON pixels in the slice. If there are no ON pixels in the slice, a waveform voltage for this slice is determined which corresponds to an angle that does not intersect the build volume (e.g., the volume of photohardenable composition included in the container). In other words, no light sheet is projected for the slice. If there are any ON pixels in the given slice, the position of the uppermost ON pixel in the height dimension of the slice and the position of the lowermost ON pixel in the slice in the height dimension of the slice are determined and the relative positions thereof are calculated relative to the full height of build volume (e.g., the full height of the volume of the photohardenable composition in the container) through which the light sheet is projected. Next, the two scan angles corresponding to these relative positions are determined and waveform voltages for the slice that correspond to the two scan angles are determined.

A third step includes creating a sequence of waveform voltages from step 2 and driving the scanner according to the sequence of waveform voltages synchronously with the projection of the optical image slices.

In this example, the height of the light sheet corresponds to the maximum height of the optical image height across the width of the slice and the portions of the volume above and below the optical image slice are not irradiated by light sheet light for the slice thereby reducing the exposure of the photohardenable composition to only light sheet light.

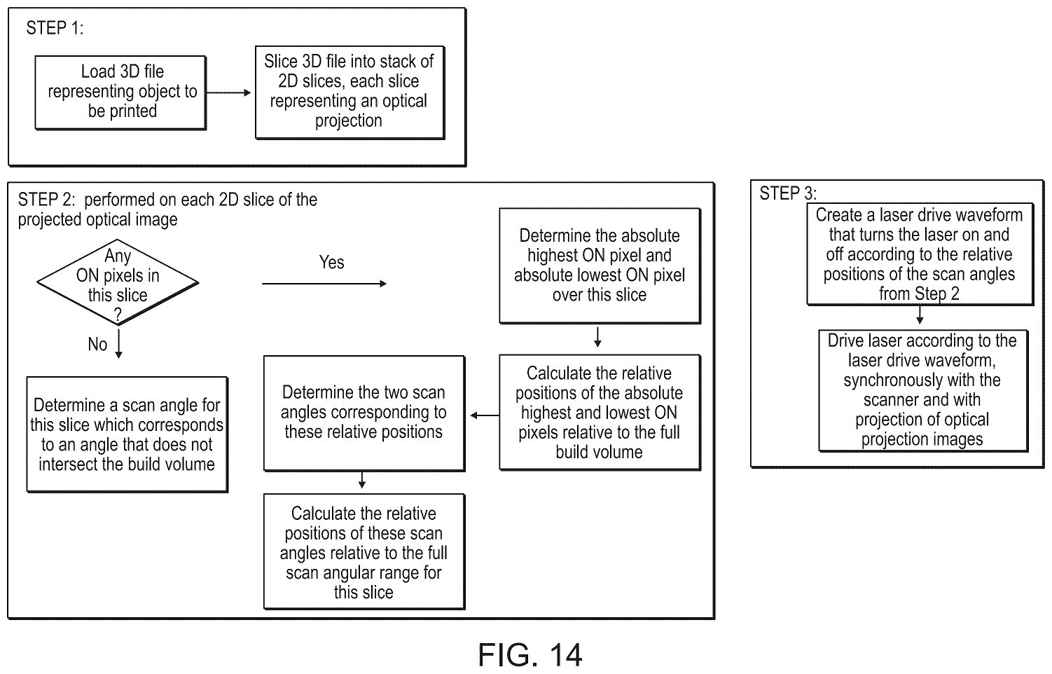

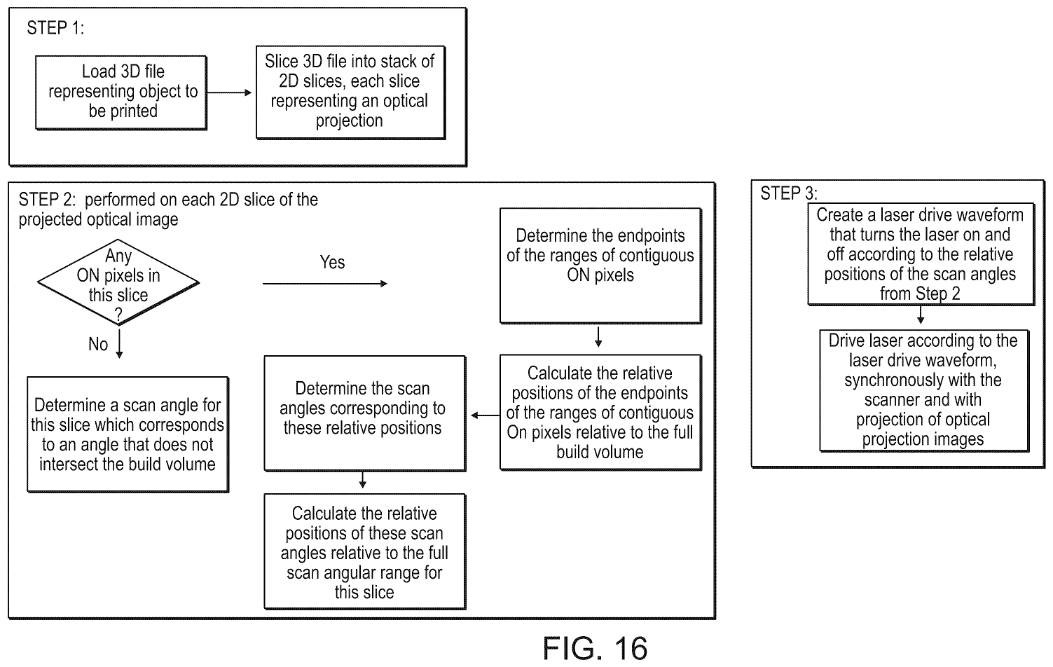

FIGS. 14 and 16 provide flow charts for examples of methods for modifying the size and/or configuration of a light sheet using an addressable or continuously running scanner and laser control.

FIG. 14 provides a flow chart for an example of an embodiment including generating a light sheet with a height that is less than the full height of the volume and using an addressable or continuously running scanner and laser control to project the light sheet.

The depicted example includes three steps.

A first step that includes loading a 3D file representing object to be printed and slicing the 3D file into stack of 2D slices, each slice representing an optical projection.

A second step that is performed on each 2D slice of the projected optical image includes determining if there are any ON pixels in the slice. If there are no ON pixels in the slice, a waveform angle for this slice is determined that corresponds to an angle that does not intersect the build volume (e.g., the volume of photohardenable composition included in the container). In other words, no light sheet is projected for the slice. If there are any ON pixels in the given slice, the position of the uppermost ON pixel in the height dimension of the slice and the position of the lowermost ON pixel in the slice in the height dimension of the slice are determined and the relative positions thereof are calculated relative to the full height of build volume (e.g., the full height of the volume of the photohardenable composition in the container) through which the light sheet is projected. Next, the two scan angles corresponding to these relative positions are determined and waveform voltages for the slice that correspond to the two scan angles are determined.

A third step includes creating a laser drive waveform that turns the laser on and off or otherwise enables and disables the laser according to the relative positions of the scan angles from step 2 and driving the scanner according to the sequence of waveform voltages synchronously with the projection of the optical image slices.

In this example, the height of the light sheet corresponds to the maximum height of the optical image height across the width of the slice and the portions of the volume above and below the optical image slice are not irradiated by light sheet light for the slice thereby reducing the exposure of the photohardenable composition to only light sheet light.

FIG. 16 provides a flow chart for an example of an embodiment for generating a light sheet with separated illuminated regions, and using an addressable or continuously running scanner and laser control to project the light sheet.

The depicted example includes three steps.

A first step that includes loading a 3D file representing object to be printed and slicing the 3D file into stack of 2D slices, each slice representing an optical projection.

A second step that is performed on each 2D slice of the projected optical image includes determining if there are any ON pixels in the slice. If there are no ON pixels in the slice, a waveform angle for this slice is determined that corresponds to an angle that does not intersect the build volume (e.g., the volume of photohardenable composition included in the container). In other words, no light sheet is projected for the slice. For the separated illuminated regions of the slice, the positions of the uppermost ON pixel in the height dimension of each illuminated region of the slice and the positions of the lowermost ON pixel in each illuminated region of the slice in the height dimension of the slice are determined and the relative positions thereof are calculated relative to the full height of build volume (e.g., the full height of the volume of the photohardenable composition in the container) through which the light sheet is projected. Next the scan angles corresponding to these relative positions are determined and the relative positions of these can angles relative to the full scan angular range for the slice are determined.

A third step includes creating a laser drive waveform that turns the laser on and off or otherwise enables and disables the laser according to the relative positions of the scan angles from step 2 and driving the laser according to the laser drive waveform, synchronously with the scanner and with the projection of optical images.

In this example, a light sheet is generated that includes separated illuminated light sheet regions with heights that corresponds to the maximum height for each of the corresponding separated illuminated regions of the optical image that the illuminated light sheet region is intended to overlap (including, when a light sheet region overlaps more than one optical image region, the non-illuminated region between the optical image regions that are being overlapped). In this example, portions of the volume above and below the overall optical image slice and, depending upon the configuration, regions between illuminated regions of the optical image are not irradiated by the light sheet alone for the slice thereby reducing the exposure of the photohardenable composition to only light sheet light.

As discussed above, in methods in accordance with the present invention, an optical image may include two or more illuminated regions that are vertically separated from each other by one or more non-illuminated regions. In such case, a controllably sized light sheet can be configured to include two or more illuminated regions that are vertically separated from each other by one or more non-illuminated regions, wherein a vertically separated illuminated region of the light sheet is aligned to overlap one or more vertically separated illuminated region or regions of the optical image at the selected location and has a height dimension to at least overlap the maximum height dimension of the one or more vertically separated region or regions of the optical image with which it is aligned to intersect. When a vertically separated region of the light sheet is configured to align with and overlap a combination of two or more vertically separated illuminated regions of an optical image at the selected location, the height dimension of such illuminated light sheet region is determined based on the total maximum height of each illuminated optical image region it overlaps plus the height of the non-illuminated optical image regions therebetween. For example, when a vertically separated region of the light sheet is configured to overlap two or more vertically separated regions of an optical image, the height of such illuminated light sheet region preferably corresponds to the combined maximum height dimension of the illuminated optical image regions it overlaps and the height of any non-illuminated optical image regions therebetween.

Optionally a projected optical image can include two or more vertically separated illuminated regions with non-illuminated regions between the illuminated regions, wherein each illuminated region and non-illuminated region of the optical image has a height dimension, and wherein the light sheet includes the same number of vertically separated illuminated regions with non-illuminated regions therebetween as the projected optical image, wherein the height and spacing of the illuminated and non-illuminated regions of the light sheet correspond to the height and spacing of the illuminated and non-illuminated regions of the optical image and are aligned therewith, such that illuminated regions of the light sheet overlap the corresponding illuminated regions of the optical projection image in the volume at the selected location.

For use in forming objects, e.g., three-dimensional objects by dual-color photopolymerization, it is desired that photohardenable compositions do not harden (e.g., the photohardenable resin component does not undergo polymerization or cross-linking) upon exposure of the photohardenable composition to only the first wavelength or only the second wavelength. In other words, hardening of the photohardenable composition in the volume which is not simultaneously or nearly simultaneously (e.g., due to the closely timed sequential exposure) exposed to both radiations do not polymerize or cross-link. In particular, in scanning a volume of the photohardenable media, as a result of beams passing through previously exposed areas or planes, there will be numerous points in the volume which are sequentially scanned in any order with the first wavelength radiation and the second wavelength radiation as the structure of the object is defined in the volume of the medium by the intersection of the beams. Some points may also experience multiple exposures to the first wavelength light and/or second wavelength light. It may be desirable to select photoswitchable photoinitiators which reverse when they are not being exposed to first wavelength light or by exposure to the second wavelength.

Preferably the amount of time during which one or more selected locations within the volume are simultaneously or sequentially exposed to the first wavelength light and the second wavelength light is sufficient to induce, e.g., at least partial hardening of the photohardenable composition at the one or more selected locations and is insufficient to cause hardening of the photohardenable composition when only one of the first and second wavelengths is present.

Preferably light including the first wavelength and light including the second wavelength are separately directed into the volume. More preferably the light including the first wavelength is directed into the volume along a first illumination axis that is orthogonal to the second illumination axis along which the light including the second wavelength is directed into the volume.

The methods described herein can further include post-processing. Examples of post-processing steps that may be further included in a method in accordance with the invention include, but are not limited to, one or more of the following: separating the printed object(s) from the unhardened photopolymerizable composition in which it(they) is(are) formed, washing, post-curing (e.g., by light, heat, ionizing radiation, pressure, or simultaneous or sequential combinations of techniques), metrology, freeze-dry processing, critical point drying, and packaging.

The methods described herein can further comprise separating the printed object from the volume of the photohardenable composition remaining after formation.

Separation of the printed object from the photohardenable composition may be conducted by a number of means known in the art, e.g., gravity draining, sieving, air blade, centrifugation, vibration, or ultrasonic agitation.

As described above, methods in accordance with the present invention can further include recovering photohardenable composition that is not solidified after removal of the printed objects for reuse, wherein the recovered photohardenable composition retains efficacy for reuse for printing additional objects.

The methods described herein can further include treating or reconditioning of the photohardenable composition remaining after separation of any printed objects. Examples of such treatments include, without limitation, cleaning/purification, filtering, centrifugation, solvent, photoswitchable photoinitiator addition, and monomer addition.

As discussed above, a photohardenable composition included in the present invention includes a photoswitchable photoinitiator which, upon exposure to a first excitation light including a first wavelength and a second excitation light including a second wavelength can induce a crosslinking or polymerization reaction in the photohardenable composition, wherein the first and second wavelengths are different.

It is desirable for the photoswitchable photoinitiator molecule in its first (non-activated) form and the photoinitiator molecule in its second (activated) form have sufficiently distinct absorption spectra that once the non-activated form of the molecule is converted to its activated second form, the activated second form absorbs in a wavelength region where the first non-activated form has minimal absorption of the first excitation wavelength or is substantially non-absorbing. This has two advantages, first, it simplifies exposure in that activation of the photoswitchable photoinitiator can occur without activating the second form thereof to alter, typically by a crosslinking or polymerization reaction in the photohardenable composition. When there is substantial overlap, the intensity of the two radiations must be carefully controlled so as to activate the photoswitchable photoinitiator molecule while minimally activating the second form thereof. Second, it can permit deeper penetration of the volume or layer of the composition as the conversion of the photoswitchable photoinitiator to the second form thereof has the effect of “bleaching” the photoswitchable photoinitiator molecule or making it transparent with respect to the first wavelength radiation.

Preferred photoswitchable photoinitiators include, but are not limited to, photochromic molecules (e.g., a photochromic dye molecule) that can be converted to an active form upon irradiation with light of a first wavelength, which active form can be further excited with a second wavelength, wherein at the intersection of the two wavelengths the photoswitchable photoinitiator is capable of inducing a crosslinking or polymerization reaction in the photohardenable composition, either alone or in combination with a coinitiator (e.g., amine, thiol, organoborate compounds, onium salts).

Examples include, but are not limited to, photoswitchable photoinitiators comprising a substituted or unsubstituted photochromic molecule, including but not limited to a substituted or insubstituted photochromic diarylethene molecule. Other examples include, but are not limited to, 1′-benzyl-3′,3′-dimethyl-8-iodo-7-methoxy-6-nitrobenzospiropyran, 1′-benzyl-3′,3′-dimethyl-8-(4-benzoylphenyl)-7-methoxy-6-nitrobenzospiropyran, and 2,2′-((6-methoxy-4-phenyl-2H-benzo[h]chromene-2,2-diyl)bis(4,1-phenylene))bis(9H-thioxanthen-9-one).

Selection of second excitation light for generating an optical image for use with a photohardenable composition takes into consideration the absorption spectrum of the photoswitchable photoinitiator included in the composition. For example, a second excitation light including red or green light can be used with a photohardenable composition including either of above examples 1′-benzyl-3′,3′-dimethyl-8-iodo-7-methoxy-6-nitrobenzospiropyran and 1′-benzyl-3′,3′-dimethyl-8-(4-benzoylphenyl)-7-methoxy-6-nitrobenzospiropyran; a second excitation light including green light is preferably used with a photohardenable composition including above example 2,2′-((6-methoxy-4-phenyl-2H-benzo[h]chromene-2,2-diyl)bis(4,1-phenylene))bis(9H-thioxanthen-9-one).

Additional information concerning photoswitchable photoinitiators and photohardenable compositions that may be useful in connection with the present invention includes that described in International Patent Application PCT/US2022/037491, filed Jul. 18, 2022, of Quadratic 3D, Inc., International Patent Application PCT/US2022/042179, filed Aug. 31, 2022, of Quadratic 3D, Inc., International Patent Application PCT/US2022/042183, filed Aug. 31, 2022, of Quadratic 3D, Inc., International Patent Application PCT/US2022/042186, filed Aug. 31, 2022, of Quadratic 3D, Inc., International Application No. PCT/US2023/022170, filed May 13, 2023, of Quadratic 3D, Inc., and International Application No. PCT/US2023/022172 of Quadratic 3D, Inc. filed May 13, 2023, each of the foregoing being hereby incorporated herein by reference in its entirety.

Non-limiting examples of first excitation wavelength ranges in which the first form of the photoswitchable photoinitiator will absorb light include, but are not limited to, from about 350 to about 460 nm (inclusive), about 350 to about 410 nm (inclusive), about 375 nm±10 nm, and about 405 nm±10 nm. Depending upon the extinction coefficient for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc. Lasers can be preferred sources of radiation for generating radiation of the first wavelength.

The second form of the photoswitchable photoinitiator will preferably absorb in a second excitation wavelength range, for example, of about 450 to about 1000 nm, about 450 to about 850 nm. Other examples of ranges in which the second form of the photoswitchable photoinitiator will preferably absorb include 470 to about 700 nm (inclusive). This form can be activated by the second excitation light to produce free radicals directly or to produce excitons which undergo electron transfer or hydrogen abstraction (optionally via electron, hydrogen, or energy transfer to coinitiator(s) in aspects of the invention including one or more coinitiator) by exposure to any second wavelength within this range. For the second excitation, exposures may be accomplished using a laser source, an LED or LED array, the filtered emission from an arc lamp, or other suitable source with emission within the desired wavelength range. argon ion, He—Ne, laser diodes, krypton, frequency-multiplied Nd-YAG etc. Other light sources may be used, optionally with filters to limit output wavelengths, e.g., light emitting diodes, incandescent lamps, halogen lamps, mercury lamps, arc lamps, etc. Lasers can be preferred sources of radiation for generating radiation of the second wavelength.

Several considerations in selecting a particular photoswitchable photoinitiator for inclusion in a photohardenable composition for use in the present invention include, by way of example, but not limited to, the absorption spectra and Aₘₐₓ of the molecule and its second forms, the solubility of the photoswitchable photoinitiator in the photohardenable resin component, the photosensitivity of the second form of the photoswitchable photoinitiator, the amount of initial concentration of the second form in the monomer solution, the stability of the photoswitchable photoinitiator and the reduction and oxidation potentials of the second form of the photoswitchable photoinitiator.

A photohardenable resin component suitable for use in a photohardenable composition useful in the present invention includes any resin (e.g., a monomer, an oligomer, a pre-polymer, a polymer, or a mixture including at least one the foregoing) that is photohardenable by exposure to light in the presence of a photoinitiator. Examples of photohardenable resin components useful for inclusion in a photohardenable composition in accordance with the present invention include ethylenically unsaturated compounds and, more specifically, polyethylenically unsaturated compounds. These compounds include both monomers having one or more ethylenically unsaturated groups, such as vinyl or allyl groups, and polymers having terminal or pendant ethylenic unsaturation. Such compounds are well known in the art and include, but are not limited to, acrylic and methacrylic esters of polyhydric alcohols such as trimethylolpropane, pentaerythritol, and the like; and acrylate or methacrylate terminated epoxy resins, acrylate or methacrylate terminated polyesters, etc. Representative examples include, but are not limited to, ethylene glycol diacrylate, ethylene glycol dimethacrylate, trimethylolpropane triacrylate (TMPTA), pentaerythritol tetraacrylate, pentaerythritol tetramethacrylate, dipentaerythritol hydroxypentacrylate (DPHPA), hexanediol-1,6-dimethacrylate, and diethyleneglycol dimethacrylate. Preferred examples include, but are not limited to, a urethane acrylate or a urethane methacrylate.

A photohardenable resin component can optionally comprise one or more multifunctional acrylate monomers. Dipentaerythritol pentaacrylate, a pentafunctional acrylic monomer available from Sartomer as SR399 is an example of a photohardenable resin component that may be desirable for inclusion in photohardenable composition of the present invention.

Aliphatic urethane acrylates may also be desirable for use as a photohardenable resin component for inclusion in a photohardenable composition described herein.

Mixtures of multifunctional acrylate monomers, such as dipentaerythritol pentaacrylate (e.g., SR399 from Sartomer), and aliphatic urethane acrylates can also be used.

A photohardenable resin component including other mixtures including one or more resin components can also be desirable.

Preferably, the photohardenable resin component included in the photohardenable composition is selected to achieve an optically transparent medium, which is desirable in processes and systems in which light, e.g., excitation light, is directed into the composition or light.

Examples of particularly preferred photohardenable resin components include, but are not limited to, free-radical-polymerizable resins, cross-linkable resins, multifunctional acrylate monomers, methacrylates, aliphatic urethane acrylates, and the like.

Optionally a solvent, preferably, for example, but not limited to, an acrylate monomer or an acrylamide monomer can be further included in a photohardenable composition for mixing the photoswitchable photoinitiator in the photohardenable resin component. Other suitable solvents may also be used.

A photohardenable composition can further include a coinitiator. (A coinitiator can also be referred to as a synergist).

Optionally, a photohardenable composition can include one or more coinitiators.

Suitable coinitiators include coinitiators which are reducing agents, oxidizing agents, or hydrogen donating compounds.

Examples of coinitiators that may be useful can be selected from among those known in the art and, more particularly, tertiary amines and organoborate salts. Iodonium salts may also be useful, particularly in combination with a borate salt. In certain embodiments, an iodonium salt may also be included in combination with a tertiary amine. Examples of other useful electron donating coinitiators are discussed by Eaton, D. F., “Dye Sensitized Photopolymerization”, Advances in Photochemistry, Vol. 13, pp 427-486.

Representative examples of N,N-dialkylanilines useful in the present invention as coinitiators include 4-cyano-N,N-dimethylaniline, 4-acetyl-N,N-dimethylaniline, 4-bromo-N,N-dimethylaniline, 4-methyl-N, N-dimethylaniline, 4-ethoxy-N,N-dimethylaniline, N,N-dimethylthioanicidine, 4-amino-N,N-dimethylaniline, 3-hydroxy-N, N-dimethylaniline, N,N,N,′N,-tetramethyl-1,4-dianiline, 4-acetamido-N,N-dimethylaniline, 2,6-diethyl-N,N-dimethylaniline, N,N,2,4,6-pentanethylaniline (PMA) and p-t-butyl-N,N-dimethylaniline.

Certain other tertiary amines are also useful coinitiators including triethylamine, triethanolamine, N-methyldiethanolamine, 2-ethyl-4-(dimethylamino)benzoate, 2-ethylhexyl-4-(dimethylamino)benzoate, etc.

Another class of useful coinitiators are alkyl borate salts such as ammonium salts of borate anions of the formula BR^{a} R^{b} R^{c} R^{d} wherein R^{a}-R^{d} are independently selected from the group consisting of alkyl, aryl, alkaryl, allyl, aralkyl, alkenyl, alkynyl, alicyclic and saturated or unsaturated heterocyclic groups. Representative examples of alkyl groups represented by R^{a}-R^{d} are methyl (Me), ethyl, propyl, butyl, pentyl, hexyl, octyl, stearyl, etc. The alkyl groups may be substituted, for example, by one or more halogen, cyano, acyloxy, acyl, alkoxy or hydroxy groups. Representative examples of aryl groups represented by R^{a}-R^{d} include phenyl, naphthyl and substituted aryl groups such as anisyl and alkaryl such as methylphenyl, dimethylphenyl, etc. Representative examples of aryl groups represented by R^{a}-R^{d} include benzyl. Representative alicyclic groups include cyclobutyl, cyclopentyl, and cyclohexyl groups. Examples of an alkynyl group aryl propynyl and ethynyl, and examples of alkenyl groups include a vinyl group. Preferably, at least one but not more than three of R^{a}, R^{b}, R^{c}, and R^{d} is an alkyl group. Each of R^{a}, R^{b}, R^{c}, and R^{d} can contain up to 20 carbon atoms, and they typically contain 1 to 7 carbon atoms. More preferably R^{a}-R^{d} are a combination of alkyl group(s) and aryl- group(s) or aralkyl group(s) and still more preferably a combination of three aryl groups and one alkyl group, i.e., an alkyltriphenylborate, e.g., but not limited to, a butyltriphenyl borate.

A photohardenable composition can optionally further include a sensitizer.

Optionally, a photohardenable composition can include one or more sensitizers.

A sensitizer can create the excited state of the photoswitchable photoinitiator via absorbing light and transferring energy to the photoswitchable photoinitiator. For example, a sensitizer can control the sensitivity of the composition and extend the spectral sensitivity of the closed form of the photoswitchable photoinitiator. Useful sensitizers include those known in the art such as acetophenone, benzophenone, 2-acetonaphthone, isopropyl thioxanthone, alkoxyketocoumarins, Esacure 3644, and the like.

Optionally, a photohardenable composition can include one or more coinitiators and one or more sensitizers.

It can also be desirable for a photohardenable compositions to display non-Newtonian rheological behavior. Advantageously such rheological behavior can facilitate forming an object in a volume of a photohardenable composition described herein upon exposure to at least two different wavelengths of excitation light wherein the object remains at a fixed position or is minimally displaced in the volume of the unhardened photohardenable composition during formation. Minimal displacement refers to displacement of the object being formed during its formation in the volume that is acceptable for precisely producing the intended part geometry. Such rheological behavior can advantageously also facilitate separation of the formed object from the unhardened photohardenable composition upon application of stress. While not wishing to be bound by theory, upon the application of stress, the apparent viscosity of the non-Newtonian photohardenable composition can drop to a lower value (e.g., the steady shear viscosity) than the static value (e.g., zero shear viscosity or yield stress) allowing the unhardened photohardenable composition to more easily flow off and separate from the object. Examples of such non-Newtonian rheological behavior include but are not limited to pseudoplastic fluid, yield pseudoplastic, Bingham plastic, Bingham pseudoplastic rheological behavior.

A photohardenable composition demonstrating non-Newtonian rheological behavior can facilitate forming an object that is fully suspended in the volume of the photohardenable composition during formation. The ability to have the object suspended in the volume during formation advantageously eliminates the need to include support structures of the type used in stereolithography to maintain the geometry/shape of the object during formation (which is sometimes referred to as printing or 3D printing).

Non-Newtonian rheological behavior can be imparted to the photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl- functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable resin component and/or by further adding one or more nonreactive additives (e.g., but not limited to, one or more thixotropes and/or rheology modifiers) to the photohardenable composition. Selection of the one or more of reactive components and the amounts thereof for addition to the photohardenable resin component to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

A photohardenable composition can preferably have a steady shear viscosity, for example, which is less than 30,000 centipoise, less than 20,000 centipoise, less than 10,000 centipoise, less than 5,000 centipoise, less than 1,000 centipoise. (Steady shear viscosity refers to the plateau value of the viscosity achieved with unidirectional constant shear, e.g., the value of the viscosity after the thixotrope network has broken up.) Steady shear viscosities may be measured at ambient (e.g., room temperature), printing temperature, or some other temperature (e.g., elevated or reduced). Measurement at printing temperature may provide advantage in determining the suitability of photohardenable composition for printing. For photohardenable composition in accordance with the present invention, preferred steady shear viscosities are less than 30,000 centipoise, more preferably less than 10,000 centipoise, and most preferably less than 1,000 centipoise.

Steady shear viscosity can be measured under continuous constant-rate shear, such as at shear rates ranging from about 0.00001 s⁻¹ to about 1000 s⁻¹.)

Optionally, photohardenable compositions can further include one or more fillers. Fillers can be included in an amount greater than 0 to about 90 weight percent, the amount being determined by the purpose for the filler and the desired end use characteristics for the intended three-dimensional object. Advantageously, fillers may be selected to maintain the optical transparency of the photohardenable composition, e.g., by controlling particle size to be substantially less than the excitation wavelengths or by matching the refractive indices of the filler and matrix to reduce optical scatter.

Fillers may be used to modify the properties of the hardened photohardenable composition, for example the stiffness, strength, toughness, impact resistance, resistance to creep, resistance to fatigue, mechanical energy return, mechanical loss tangent, glass transition temperature, thermal degradation temperature, thermal conductivity, thermal resistance, moisture uptake, electrical conductivity, static dissipation, dielectric constant and loss tangent, density, refractive index, optical dispersion, opacity to ionizing radiation, and resistance to ionizing radiation. Fillers may also be used to modify the properties of the liquid photohardenable composition, such as rheological properties such as viscosity and thixotropy and optical properties such as refractive index. Examples of fillers include but are not limited to silica, alumina, zirconia; silicates glasses such as soda-lime glass, borosilicate glass, sodium silicate glass, lead glass, aluminosilicate glass, barium glass, thorium glass, glass ceramics; chalcogenide glasses; glass microspheres and microbubbles; nanoclays such as laponite, montmorillonite, bentonite, kaolinite, hectorite, and halloysite; calcium phosphate minerals such as hydroxyapatite, mineral fillers such as chalk, rock dust, slag dust, fly ash, hydraulic cement, loess, limestone, kaolin, talc, and wollastonite. Examples of particle size ranges include but are not limited to less than 10 microns, less than 1 micron, 10 nm to 500 nm, 10 nm to 90 nm, 40 nm to 70 nm. Smaller particles sizes, in particular sizes less than about 100 nm, may be beneficial to provide high optical clarity of the liquid composition to better facilitate printing. Controlling the particle size distribution, for example monodisperse, bimodal, or trimodal distributions of sizes, may be beneficial to control rheological properties, increase filler weight percent, or modify the properties of the photohardenable composition.

Photohardenable compositions can further include one or more additives. Examples of additives include, but are not limited to, a filler, a thixotrope/rheology modifier, a defoamer, a stabilizer, an oxygen scavenger, a non-reactive solvent diluent, and a colorant. Any additive can be a single additive or a mixture of additives. For example, a thixotrope can comprise a single thixotrope or a mixture of two or more thixotropes.

Additives are preferably selected so that they do not react with other components or additives that may be included in photohardenable compositions.

Thixotropes and rheology modifiers suitable for inclusion in a photohardenable composition include, for example and without limitation, urea derivatives; modified urea compounds such as Rheobyk 410 and Rheobyk-D 410 available from BYK-Chemie GmbH, part of the ALTANA Group; fumed metal oxides (also referred to as pyrogenic metal oxides) including for example, but not limited to, fumed silica, fumed alumina; zirconia; precipitated metal oxides including for example, but not limited to, precipitated silica, precipitated alumina; unmodified and organo-modified phyllosilicate clays; dimer and trimer fatty acids; polyether phosphates; oxidized polyolefins; hybrid oxidized polyolefins with polyamide; alkali soluble/swellable emulsions; cellulosic ethers; hydrophobically-modified alkali soluble emulsions; hydrophobically-modified ethylene oxide-based urethane; sucrose benzoate; ester terminated polyamides; tertiary amide terminated polyamides; polyalkyleneoxy terminated polyamides; polyether amides; acrylamidomethyl-substituted cellulose ester polymers; polyethyleneimine; polyurea; organoclays; hydrogenated castor oil; organic base salts of a clay mineral (e.g., montmorillonite) and other silicate-type materials; aluminum, calcium, and zinc salts of fatty acids, such as lauric or stearic acid.

See U.S. Pat. No. 6,548,593 of Merz, et al., issued Apr. 15, 2003, and 9,376,602 of Walther, et al. issued Jun. 28, 2016, which are hereby incorporated herein by reference in their entireties, for information relating to urea derivatives that may be useful as thixotropes.

Thermally reversible gellants such as ester terminated polyamides, tertiary amide terminated polyamides, polyalkyleneoxy terminated polyamides, and polyether amides, and combinations thereof, may be desirable for us as thixotropes. Examples include Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73, and Rheoptima X84 available from Croda. Crystasense HP-5 is a preferred example of a thixotrope.

Metal oxides that have been surface-treated to impart dispersibility characteristics compatible with the photohardenable resin component may be desirable for use as thixotropes.

A thixotrope can be included in a photohardenable composition described herein in an amount in a range from about 0.5 weight percent to about 15 weight percent of the photohardenable composition.

A thixotrope is preferably included in a photohardenable composition in an amount effective to at least partially restrict movement of the three-dimensional object or one or more regions thereof in the photohardenable composition during formation.

More preferably, the thixotrope is included in the photohardenable composition in an amount effective to at least partially restrict movement of the three-dimensional object suspended (without contact with a container surface) in the volume of the photohardenable composition during formation. Most preferably the position of the object in the volume of the photohardenable composition remains fixed position during formation of the object.

A defoamer can be included to aid in removing bubbles introduced during processing and handling. A preferred defoamer is BYK 1798 (a silicone based defoamer) available from BYK-Chemie GmbH, part of the ALTANA Group.

A stabilizer can be included to improve shelf-life of the photohardenable composition and/or to control the level of cure and/or spatial resolution during printing. An example of preferred stabilizer is TEMPO (2,2,6,6-tetramethylpiperidinooxy free radical available from Sigma-Aldrich). Examples of other stabilizers include, but are not limited to, hindered phenols such as butylated hydroxytoluene; hydroquinone and its derivatives such as hydroquinone methyl ether; hindered amine light stabilizers; alkylated diphenylamines; and phosphite esters.

An oxygen scavenger can be included to react with oxygen (e.g., singlet oxygen, dissolved oxygen) present in the photohardenable composition.

A non-reactive solvent diluent can be included. Examples include, but are not limited to, acetone, amyl acetate, n-butanol, sec-butanol, tert-butanol, butyl acetate, cyclohexanone, decane, dimethylacetamide, dimethylformamide, dimethylsulfoxide, dipropylene glycol, dipropylene glycol methyl ether, ethanol, ethyl acetate, ethylene glycol, glycerol, heptane, isopropanol, isopropyl acetate, methyl ethyl ketone, N-methyl pyrrolidone, propylene carbonate, propylene glycol, propylene glycol diacetate, tetrahydrofuran, tripropylene glygol methyl ether, toluene, water, xylenes.

Unless otherwise indicated, specified weight percents are based on the total weight of the photohardenable composition.

The nature of the photohardenable resin component, the amount of the photoswitchable photoinitiator, and other optional additives included in photohardenable compositions will vary with the particular use of the compositions, the emission characteristics of the exposure sources, desired properties of the printed object, and other factors.

Examples of photohardenable compositions including a photoswitchable photoinitiator, a photohardenable resin component, and one or more coinitiators and/or sensitizers can have compositions which fall within the following compositional ranges in parts by weight [based on 100 parts total]:
Photoswitchable photoinitiator: about 0.0001 to about 0.5, including, for example, but not limited to, about 0.0001 to about 0.1, about 0.0001 to about 0.05, about 0.0001 to about 0.01, about 0.0001 to about 0.005, from about 0.0001 to about 0.0025, etc.
Coinitiators (optional) about 0.001 to about 10 including, for example, but not limited to, about 0.001 to about 7.5, about 0.001 to about 5, about 0.001 to about 2.5, about 0.001 to about 1, about 0.001 to about 0.5, from about 0.0001 to about 0.25, etc.
Sensitizer (optional) about 0.1 to about 1, including, for example, but not limited to, about 0.1 to about 0.75, about 0.1 to about 0.5, about 0.1 to about 0.25, etc.
Photohardenable resin component—the balance of the photohardenable composition

Examples of photohardenable compositions including a photoswitchable photoinitiator, a photohardenable resin component, and not including one or more coinitiators and/or sensitizers can have compositions which fall within the following compositional ranges in parts by weight [based on 100 parts total]:
Photoswitchable photoinitiator: about 0.0001 to about 0.5, including, for example, but not limited to, about 0.0001 to about 0.1, about 0.0001 to about 0.05, about 0.0001 to about 0.01, about 0.0001 to about 0.005, from about 0.0001 to about 0.0025, etc.
Photohardenable resin component—the balance of the photohardenable composition

The above describes compositions and compositional ranges for non-limiting examples of photohardenable compositions in accordance with the invention. Variations of the above examples of the photohardenable composition described herein and compositional ranges for the constituents included therein may also be determined to be suitable and within the scope of the present invention.

In methods described herein, each wavelength is preferably generated by a different light source or optical projection system.

Methods in accordance with the invention preferably include providing a volume of a photohardenable composition within a container wherein at least a portion of the container is optically transparent so that the photohardenable composition is accessible by excitation light. Optionally, the entire container is optically transparent.

Optically transparent portions of a container can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic.

Examples of container shapes include, but are not limited to, a cylindrical container having a circular or oval cross-section, a container having straight sides with a polygonal cross-section or a rectangular or square cross-section.

Preferably the optically transparent portion(s) of the container is (are) also optically flat.

Optionally, one or more filters can be added to at least a surface of any optically transparent portions of the container to block undesired light, e.g., room light, to prevent unintentional curing.

Optionally the photohardenable composition is filtered to remove particulates before introduction into the container. Optionally bubbles are removed from the photohardenable composition before or after being introduced into the container.

Optionally the photohardenable composition is degassed, purged or sparged with an inert gas before or after being introduced into the container. Optionally the photohardenable composition is maintained under inert conditions, e.g., under an inert atmosphere, during printing. This can prevent introduction of oxygen into the container while the object is being printed or formed.

The methods disclosed herein can also include the use commercially available optical projection and filtering techniques or systems that employ two or more optical projection methods at once.

The radiation or excitation source for the first excitation is preferably selected to emit radiation at a wavelength or within a range of wavelengths absorbed by the particular photoinitiator, e.g., the photoswitchable photoinitiator.

Excitation light or radiation for the first or second excitation may be applied using any suitable light or electromagnetic radiation source or optical system (which typically includes a light or electromagnetic radiation source). Examples of light or electromagnetic radiation light sources include, but are not limited to, lasers (including laser diodes) and other coherent light sources, light-emitting diodes (LEDs), micro-LED arrays, vertical cavity lasers (VCLs), and filtered lamps. Such light sources are commercially available and selection of a suitable light source can be readily made by one of ordinary skill in the relevant art. LEDs of the type such as Phlatlight LEDs available from Luminus for use with DMDs may also be suitable.

Lasers can be preferred sources of radiation for use in generating a planar configuration of light or a light sheet. Lasers can also be preferred sources for use in projecting an optical image.

Examples of projection devices suitable for use in projecting optical images or planar configurations of light (also referred to herein as light sheets) in the methods described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LcoS”) projector, and a scanning laser system. (Light emitting diode is also referred to herein as “LED”).

An optical image is preferably a two-dimensional image. Examples include a cross-sectional plane of the three-dimensional image or object being printed.

Excitation light applied as a controlled or sized planar configuration of light or a light sheet is preferably generated as set forth above. Other suitable techniques can also be used.

Optionally, the first and/or second excitation light can be temporally and/or spatially modulated or otherwise selectively enabled and disabled. Optionally, the intensity of the excitation light can be modulated or otherwise selectively enabled and disabled by known or readily ascertainable techniques. Optionally, source drive modulation or selective enablement and disablement by known or readily ascertainable techniques can be used to adjust the absolute power of the light beam.

Spatially modulated excitation light can be used to direct or irradiate a patterned image or a two-dimensional image at one or more selected locations in the photohardenable composition.

For example, spatially modulated first and/or second excitation light can be created by an optical projection system including a spatial modulation component (also referred to herein as a spatial light modulator (“SLM”)). Examples of spatial modulation components for inclusion in an optical projection system include, for example and without limitation, a liquid crystal display (also referred to herein as “LCD”), a digital micromirror device (also referred to herein as “DMD”)), a micro-LED array, a vertical cavity laser (also referred to herein as “VCL” or as a Vertical Cavity Surface Emitting Laser (also referred to herein as “VCSEL”), a scanning laser system, a liquid crystal on silicon (also referred to herein as “LcoS”) microdisplay.

An optical projection system comprising a spatial light modulator may be utilized with coherent or incoherent light as an amplitude modulator in combination with projection lens to form images or planar configurations of light in the photopolymerizable composition.

A preferred optical projection system for the first and/or second excitation can include a light source, illumination optics, projection optics, and a spatial modulation component.

An optical projection system for the first and/or second excitation can be selected to apply continuous excitation light. An optical system can be selected to apply intermittent excitation light. Intermittent excitation can include random on or enabling and off or disabling application of light or periodic application of light. Examples of periodic application of light includes pulsing. An optical system can be selected to apply a combination of both continuous excitation light and intermittent light, including, for example, an irradiation step that includes the application of intermittent excitation light that is preceded or followed by irradiation with continuous light.

An optical projection system for the first and/or second excitation can further include projection optics and/or additional components including, but not limited to, one or more translational stages for moving the system or components thereof.

The method disclosed herein can also include the use of commercially available projection and filtering techniques that can assist in providing a very narrow depth of focus or systems that employ two or more optical projection methods at once.

In methods described herein, power densities or intensities of excitation light directed into the volume of photohardenable composition to cause partial hardening (e.g., by polymerization, crosslinking) to occur at the one or more selected locations may be, without limitation, in a range from about 0.01 to about 100,000 W/cm² (inclusive).

Other power densities or intensities may also be determined to be useful.

In the methods described herein, the container optionally may be rotated to provide additional angles of illumination or projection of excitation light into the volume of photohardenable composition contained therein. This can be of assistance in patterning object volumes or surfaces more accurately or it can be used as a means of providing multiple exposure of a given feature from different angles.

In the method described herein, the container optionally may be stationary while a beam or optical projection of excitation light is being directed into the photohardenable composition.

Before printing, a digital file of the object or object to be printed is typically obtained. If the digital file is not of a format that can be used to print the object, the digital file is then converted to a format that can be used to print the object. An example of a typical format that can be used for printing includes, but is not limited to, an STL file. Typically, the STL file is then sliced into two-dimensional layers with use of three-dimensional slicer software and converted into G-Code or a set of machine commands, which facilitates building the object. See B. Redwood, et al., “The 3D Printing Handbook—Technologies, designs applications”, 3D HUBS B.V. 2018.

Other information concerning optical systems that may useful in connection with the various aspects of the present inventions includes Texas Instruments Application Report DLPA022-July 2010 entitled “DLP™ System Optics”; Texas Instruments “TI DL^{R} Technology for 3D Printing—Design scalable high-speed stereolithography [sic] systems using TI DLP technology” 2016; Texas Instruments “DLP6500 0.65 1018p MVSP Type A DMD”, DLP6500, DLPS040A-October 2014—Revised October 2016; and Y-H Lee, et al., “Fabrication of Periodic 3D Nanostructuration for Optical Surfaces by Holographic Two-Photon-Polymerization”, Int'l Journal of Information and Electronics Engineering, Vol 6, No. 3, May 2016, each of the foregoing being hereby incorporated herein by reference in its entirety.

In accordance with another aspect of the present invention there is provided a photohardenable composition including a photoswitchable photoinitiator and a photohardenable resin component that has been recovered from a method in accordance with the present invention wherein the composition retains efficacy for reuse for printing additional objects.

It is desirable for the composition to retain efficacy for reuse at least two times.

A light sheet is also referred to herein as a planar configuration of light, and the terms are used interchangeably.

Height dimension is also referred to herein as height or vertical dimension, and the terms are used interchangeably.

The present invention may be embodied in various forms. For convenience, the terms “upper” and “lower” and “top” and “bottom” are used herein to differentiate between the upper and lower ends of the components described herein. The terms “inner” and “outer” are used herein to differentiate between the inner and outer portions of the components described herein. It is to be appreciated that “upper” and “lower”, and “top” and “bottom”, and “inner” and “outer” are used only for ease of description and understanding and that they are not intended to limit the possible spatial orientations of the components described herein during assembly or use.

When used as a characteristic of a portion of a container or build chamber, “optically transparent” refers to having high optical transmission to the wavelength of light being used, and “optically flat” refers to being non-distorting (e.g., optical wavefronts entering the portion of the container or build chamber remain largely unaffected with passage through the surface of the container or build chamber).

As used herein, the singular forms “a”, “an” an” “the” include plural unless the context clearly dictates otherwise. Thus, for example, reference to an emissive material includes reference to one or more of such materials.

Additional information that may be useful in connection with the present invention includes U.S. patent application Ser. No. 18/073,702 of Quadratic 3D, Inc. filed Dec. 2, 2022 for “Volumetric Three-Dimensional Printing Methods Including A Light Sheet And System”, International Patent Application No. PCT/US2021/035791 of Quadratic 3D, Inc. filed Jun. 3, 2021 for “Volumetric Three-Dimensional Printing Methods Including A Light Sheet And Systems”, International Patent Application PCT/US2022/037491, filed Jul. 18, 2022, of Quadratic 3D, Inc., International Patent Application PCT/US2022/042179, filed Aug. 31, 2022, of Quadratic 3D, Inc., International Patent Application PCT/US2022/042183, filed Aug. 31, 2022, of Quadratic 3D, Inc., and International Patent Application PCT/US2022/042186, filed Aug. 31, 2022, of Quadratic 3D, Inc., International Application No. PCT/US2022/039766 of Quadratic 3D, Inc. filed Aug. 9, 2022 for “Methods And Systems For Forming An Object In A Volume Of A Photohardenable Composition”, and International Application No. PCT/US2023/022171, filed May 13, 2023, of Quadratic 3D, Inc., each of the foregoing and other references cited herein being hereby incorporated herein by reference in its entirety.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1-28. (canceled)

29. A method of three-dimensional (3D) printing, the method comprising exposing a volume of a photohardenable composition including a photoswitchable photoinitiator and a photohardenable resin component to a projected optical image having a height dimension created by second excitation light and a light sheet generated with first excitation light such that the projected optical image and light sheet intersect in a common plane at a selected location in the volume to induce polymerization or cross-linking of the composition at the selected location, wherein the size of the light sheet intersecting with the projected optical image is controlled to reduce regions of the volume exposed only to first excitation light thereby reducing photoexcitation of the photoswitchable photoinitiator in the photohardenable composition.

30. The method of claim 29 wherein the light sheet is directed into the volume along a light sheet illumination axis, wherein each of the light sheet and the volume has a height dimension and the height dimension of the light sheet along the light sheet illumination axis is less than the height dimension of the volume of the photohardenable composition through which the light sheet is directed and greater than or equal to height dimension of the projected optical image in the volume at the selected location, and wherein the light sheet at least fully overlaps the projected optical image in the volume at the selected location.

31. The method of claim 29 wherein the method is repeated one or more times to partially or fully form an object, wherein when the method is repeated, the selected location is the same as or different from a previous selected location, the projected optical image is the same as or different from a previous projected optical image, and the size of the light sheet intersecting with the projected optical image is controlled to reduce regions of the volume exposed only to first excitation light thereby reducing excitation of the photoswitchable photoinitiator in the photohardenable composition.

32. The method of claim 30 wherein the method is repeated one or more times to partially or fully form an object, wherein when the method is repeated, the selected location is the same as or different from a previous selected location, the projected optical image is the same as or different from a previous projected optical image, and the height dimension of the light sheet is adjusted so that it is less than the height dimension of the volume through which the light sheet is passed and greater than or equal to the height dimension of the projected optical image at the selected location in the volume, and wherein the light sheet at least fully overlaps the projected optical image in the volume at the selected location for the repeated step.

33. The method of claim 29 wherein the projected optical image includes two or more vertically separated illuminated regions with non-illuminated regions between the illuminated regions, wherein each illuminated region and non-illuminated region has a height dimension, and wherein the controllably-sized light sheet includes two or more illuminated regions that are vertically separated from each other by a non-illuminated region, wherein a vertically separated illuminated region of the light sheet is aligned to overlap one or more vertically separated illuminated regions of the projected optical image at the selected location and has a height dimension to at least overlap the maximum height dimension of the one or more vertically separated regions of the projected optical image with which it is aligned to intersect including any non-illuminated regions of the projected optical image therebetween.

34. The method of claim 29 wherein the projected optical image includes two or more vertically separated illuminated regions with non-illuminated regions between the illuminated regions, wherein each illuminated region and non-illuminated region of the projected optical image has a height dimension, and wherein the light sheet includes the same number of vertically separated illuminated regions with non-illuminated regions therebetween as the projected optical image, wherein the height and spacing of the illuminated and non-illuminated regions of the light sheet correspond to the height dimension and spacing of the illuminated and non-illuminated regions of the projected optical image and are aligned therewith, such that illuminated regions of the light sheet overlap the corresponding illuminated regions of the optical projection image in the volume at the selected location.

35. The method of claim 29 wherein an projected optical image comprises a two-dimensional cross-sectional slice of an object to be printed.

36. The method of claim 30 wherein the height dimension of the light sheet substantially matches the height dimension of the projected optical image in the volume at the selected location, and wherein the light sheet fully overlaps the projected optical image in the volume at the selected location.

37. The method of claim 30 wherein the projected optical image comprises a two-dimensional cross-sectional slice of an object to be printed.

38. The method of claim 31 wherein the projected optical image comprises a two-dimensional cross-sectional slice of an object to be printed and the projected optical image of a repeated step comprises a sequential two-dimensional cross-sectional slice of the object.

39-40. (canceled)

41. The method of claim 29 wherein reducing regions of the volume exposed only to first excitation light increases the reuse-printing lifetime thereof.

42. (canceled)

43. The method of claim 33 wherein the two or more vertically separated illuminated regions with non-illuminated regions between the illuminated regions are generated by a generation method including use of a spatial light modulator wherein the illuminated regions of the light sheet are illuminated by turning-on spatial light modulator pixels corresponding to the illuminated regions and non-illuminated regions of the light sheet are not illuminated by turning-off spatial light modulator pixels corresponding to non-illuminated regions, such that the illuminated regions of the light sheet fully overlap the corresponding illuminated regions of the optical projection image in the volume at the selected location.

44. (canceled)

45. The method of claim 33 wherein the two or more vertically separated illuminated regions with non-illuminated regions between the illuminated regions are generated by a generation method including a light source and a scanner and synchronizing the light source emission and the scanner scan angle such that the illuminated regions of the light sheet are illuminated by enabling the light source when the scan angle is such that the scanner would direct light towards the illuminated regions and the non-illuminated regions of the light sheet are not illuminated by disabling the light source when the scan angle is such that the scanner would direct light towards the non-illuminated regions, such that the illuminated regions of the light sheet fully overlap the corresponding illuminated regions of the optical projection image in the volume at the selected location.

46. (canceled)

47. The method of claim 29 wherein the controllably-sized light sheet is generated by a generation method including use of a spatial light modulator wherein the size of the light sheet is sized by turning-off or turning-on spatial light modulator pixels selected to produce the desired height based on the height dimension of the projected optical image.

48. The method of claim 29 wherein the controllably-sized light sheet is generated by a generation method including use of a scanner.

49. The method of claim 29 wherein the controllably-sized light sheet is generated by a generation method including use of an addressable scanner.

50-51. (canceled)

52. The method of claim 48 wherein light from a light source illuminating the scanner generating the light sheet is selectively enabled or disabled.

53-54. (canceled)

55. The method of claim 52 wherein enabling the light source is synchronized to when the angular position of the scanner is in an angular range corresponding to the height dimension of the projected optical image.

56-133. (canceled)

134. A photohardenable composition comprising a photoswitchable photoinitiator and a photohardenable resin component that has been recovered from the method of claim 29, wherein the recovered photohardenable composition retains efficacy for reuse for printing additional objects.

135. (canceled)

136. The photohardenable composition of claim 134 wherein the photoswitchable photoinitiator comprises a photochromic molecule comprising a substituted diarylethene molecule.

137-141. (canceled)
